(19) United States
(12) Patent Application Publication
(10) Pub. No.: US 2014/0051109 A1
(43) Pub. Date: Feb. 20, 2014

(54) NOVEL COMPOUNDS WITH PHOTOLUMINESCENCE PROPERTIES AND APPLICATIONS THEREOF

(71) Applicants: Young-Tae Chang, Singapore (SG); Jae-Jung Lee, Singapore (SG); Sung-Chan Lee, Singapore (SG)

(72) Inventors: Young-Tae Chang, Singapore (SG); Jae-Jung Lee, Singapore (SG); Sung-Chan Lee, Singapore (SG)

(73) Assignee: Agency for Science, Technology and Research, Singapore (SG)

(21) Appl. No.: 14/002,247

(22) PCT Filed: Mar. 1, 2012
(86) PCT No.: PCT/SG2012/000060

§ 371 Date: Nov. 6, 2013

Related U.S. Application Data
(60) Provisional application No. 61/448,097, filed on Mar. 1, 2011.

(51) Int. Cl. G01N 21/64

(52) U.S. Cl. CPC G01N 21/6486
USPC 435/29; 548/405; 544/69; 530/326

(57) ABSTRACT

The present invention relates to compounds of a general formula (I) having photoluminescence properties. The present invention also relates to applications, such as protein imaging tools, involving such compounds.

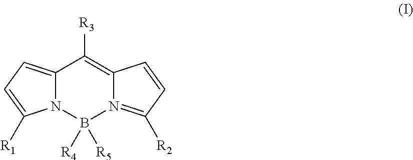

### TECHNICAL FIELD

The present invention generally relates to novel compounds having photoluminescence properties and applications involving such compounds.

### BACKGROUND

Site-specific labeling of target proteins with photophysical reporter probes allows numerous in vivo studies of protein functions. One way to achieve site-specific labeling of target proteins is through genetic fusion of a protein of interest and a fluorescent protein, thereby enabling the protein of interest to be observed in cells or tissues using fluorescence microscopy. Although genetic fusion of the fluorescent proteins provides critical advantages, its adverse properties such as large size (e.g. 27 kDa) or aggregation often limit the application of the fusion proteins.

Alternatively, a small peptide tag and a corresponding binding probe would provide a less invasive way of protein labeling. A pioneering example of such protein labeling utilizes the affinity between a tetracysteine tag and a fluorescent biarsenical probe (referred to as FIAsH). To date, a number of peptide tags have been developed based on two principles in general: i) by exploiting the intrinsic affinity between a probe and a peptide tag, as in the instance of the D4 tag/Zn-probe or IQ-tag; and ii) by conjugating a probe to a peptide tag with the assistance of an transacting enzyme, as in the instance of the AviTag, LAP-tag or AcP/PCP tag.

However, application of above systems, except the FIAsH, is limited to the extracellular domain of membrane proteins because of the cell-impermeability of labeling reagents including the modifying enzymes. Therefore, notwithstanding the toxicity of arsenical probes, FIAsH still is the most representative peptide-based method applicable inside cells.

In addition to their toxicity, the FIAsH probes are also restricted in their applications. The biarsenical probes are commonly based on a fluorescein fluorophore and have equivalent distances between the two arsenic atoms. The equivalent distances render these probes generally only suitable to bind the same tetracysteine tag with the same amino acid sequence (CysCysProGlyCysCys).

There is a need to provide a labeling probe that does not comprise arsenic atoms and hence does not exhibit the known cytotoxicity associated with the arsenic atoms.

There is a need to provide a more flexible probe/tag system, which may be used to label proteins in different environments.

There is a need to provide tools for an imaging system that overcomes, or at least ameliorates, one or more of the disadvantages described above.

### SUMMARY

According to a first aspect, there is provided a compound of formula I

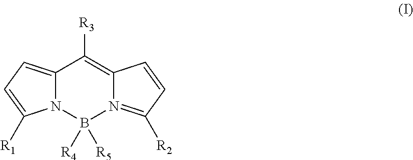

or a salt thereof, wherein
each of R₁ and R₂ is an optionally substituted alkene having at least one electron withdrawing group moiety;
R₃ is selected from the group consisting of hydrogen, optionally substituted aryl, hydroxyl, amine, sulfonic acid and an optionally substituted aliphatic group;
R₄ and R₅ are independently selected from halogen or an aliphatic group.

Advantageously, the compound of formula I has a conjugated system which exhibits a unique fluorescence property. The core structure of the compound of formula I is boron dipyrrolemethene (Bodipy). Bodipy is selected as the core structure of the compound of formula I as it is a fluorophore which emits strong green fluorescence with high quantum yield and sharp excitation/emission wavelengths.

Advantageously, by introducing substituents R₁ and R₂ on the Bodipy core structure, the alkene moieties present in the substituents are able to extend the conjugated system beyond the Bodipy core and thereby shifts the excitation and emission wavelength of the Bodipy core significantly to a longer wavelength. Accordingly, a compound of formula I has a unique fluorescence property and emits in the orange or red region of the visible light spectrum, for example, as opposed to the Bodipy core which emits in the green region.

Advantageously, in each of R₁ and R₂, the presence of at least one electron withdrawing group moiety facilitates a nucleophilic attack on the alkene moiety, thereby enabling a bond to be formed between the compound of formula I and a binding partner via an addition reaction which may take place at the alkene moiety of R₁ or R₂.

In one embodiment, there is provided a compound of formula I-A

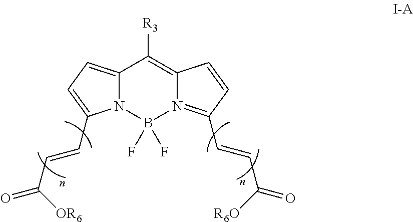

wherein
n is an integer selected from 1 to 10, 1 to 7, 1 to 4 or n=1, n=2 or n=3;
R₃ is independently selected from hydrogen or optionally substituted aryl;
R₆ is hydrogen or a lower alkyl with 1 to 6 carbon atoms.

In one embodiment, there is provided a compound of formula I-B

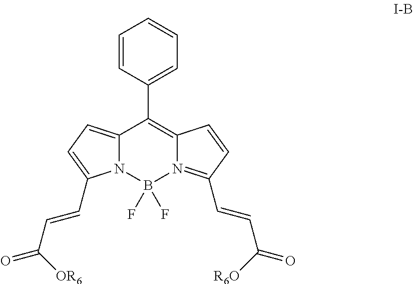

wherein R₆ is hydrogen or a lower alkyl with 1 to 6 carbon atoms.

In one embodiment, there is provided a compound of formula I-C

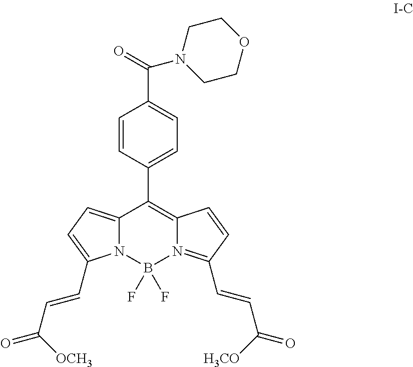

According to a second prospect, there is provided a peptide segment comprising two or more cysteine group capable of binding with a disclosed compound to, thereby induce a change in a fluorescence property of the compound, the peptide segment capable of being coupled to, or being integrated within a sequence of, a target protein.

Advantageously, each cysteine group comprises a nucleophilic thiol moiety which may undergo an addition reaction and form a covalent bond with the alkene moiety of substituent R₁ or R₂ of a disclosed compound. Advantageously, the addition reaction at the alkene moiety may break the conjugation in the extended conjugated system of the disclosed compound, and thereby shifting the fluorescence back to the green colour of the Bodipy core. Advantageously, the change in fluorescence properties of the disclosed compound upon binding to a disclosed peptide segment may be used to assist the imaging of a target protein.

In one embodiment, the peptide segment may comprise two cysteine groups, each paired with an arginine.

According to a third aspect, there is provided a complex comprising a disclosed compound covalently bound to a disclosed peptide segment.

According to a fourth aspect, there is provided a use of a disclosed compound as an imaging probe in conjunction with a disclosed peptide segment.

According to a fifth aspect, there is provided a method of imaging a target protein in a biological matrix, the method comprising the steps of:
a) providing at least one disclosed peptide segment to tag a target protein;
b) providing a compound of formula I to enable covalent binding between the compound of formula I and the at least one peptide segment; and
c) imaging the bound complex in the biological matrix.

Advantageous, the disclosed method may be used to image a target protein in an intracellular or extracellular environment.

According to a sixth aspect, there is provided an imaging kit comprising a disclosed compound of formula I-A, I-B or I-C as an imaging probe and at least one disclosed peptide segment comprising two cysteine groups, each paired with an arginine.

Advantageously, the disclosed compound does not comprise a toxic element such as arsenic. Therefore, the disclosed compound may be safely used as an imaging probe.

Advantageously, with the disclosed compounds being relatively small molecules and the disclosed peptide segments being small peptide segments, they may be used as a probe/peptide tag combination to examine protein in extracellular or intracellular environments.

### DEFINITIONS

The following are some definitions that may be helpful in understanding the description of the present invention. These are intended as general definitions and should in no way limit the scope of the present invention to the defined terms alone. The definitions are put forth for a better understanding of the following description.

Those skilled in the art will also appreciate that the invention described herein is susceptible to variations and modifications other than those specifically described. It is to be understood that the invention includes all such variations and modifications. The invention also includes all of the steps, features, compositions and compounds referred to or indicated in this specification, individually or collectively, and any and all combinations or any two or more of said steps or features.

The term “electron withdrawing group” as used herein refers to a functional group that can attract electrons in a covalent bond or from another functional group, such as an alkene, towards itself.

The term “aliphatic” is to be interpreted broadly to include a linear, branched, or cyclic alkyl, alkenyl, or alkynyl group, which may contain oxygen, nitrogen, chlorine or sulfur atoms. Therefore, the term “aliphatic” as used herein may refer to an alkoxy group, for example.

The term “alkoxy” as used herein refers to straight chain or branched alkyloxy groups. Examples include methoxy, ethoxy, n-propoxy, isopropoxy, tert-butoxy, and the like.

The term “lower alkyl” as used herein refers to a straight or branched saturated hydrocarbon chain having 1, 2, 3, 4, 5 or 6 carbon atoms.

The term “aryl” or variants such as “aromatic group” or “arylene” as used herein refers to any functional group or substituent derived from an aromatic ring. The term “aryl” also includes any single ring, conjugated or fused residues of aromatic hydrocarbons having from 6 to 20 carbon atoms. Exemplary aryl groups include, but are not limited to phenyl, tolyl, naphthyl and the like.

The term “halide” or variants such as “halogen” or “halo” as used herein refers to fluoride, chloride, bromide and iodide.

The term “amine” as used herein refer to functional groups that contain a basic nitrogen atom with a lone pair, including, but not limited to, —NH₂, —NH(alkyl) and —N(alkyl)₂.

The term “optionally substituted” as used herein means the group to which this term refers may be unsubstituted, or may be substituted with one or more groups independently selected from hydrogen, oxygen, sulfur, alkyl, alkenyl, alkynyl, thioalkyl, cycloalkyl, cycloalkenyl, heterocycloalkyl, halo, carboxyl, haloalkyl, haloalkynyl, hydroxyl, alkoxy, thioalkoxy, alkenyloxy, haloalkoxy, haloalkenyloxy, nitro, amino, nitroalkyl, nitroalkenyl, nitroalkynyl, nitroheterocyclyl, alkylamino, dialkylamino, alkenylamine, alkynylamino, acyl, alkenoyl, alkynoyl, acylamino, diacylamino, acyloxy, alkylsulfonyloxy, heterocycloxy, heterocycloamino, haloheterocycloalkyl, alkylsulfenyl, alkylcarbonyloxy, alkylthio, acylthio, phosphorus-containing groups such as phosphonyl and phosphinyl, aryl, heteroaryl, alkylaryl, alkylheteroaryl, cyano, cyanate, isocyanate, —C(O)NH(alkyl), and —C(O)N(alkyl)₂.

The term “conjugation” as used herein generally refers to the overlap of one p-orbital with another. The conjugated p-orbitals are separated by a sigma bond. The term ‘conjugated system’ as used herein generally refers to a system with alternating single and double bonds. A conjugated system allows delocalization, or movement, of pi electrons across all the adjacent p-orbitals. Therefore, the pi electrons do not belong to a particular atom or a particular pair of atoms, but are shared throughout the conjugated orbitals. Conjugation generally results in a system with a lower overall energy and thereby results in greater stabilization of the compound or molecule comprising the conjugated system.

The term “probe” as used herein refers to a compound or a molecule that is designed to bind a peptide or nucleotide sequence. The ‘probe’ aspect of the compound or molecule indicates that the compound or molecule has means, e.g. a change in fluorescence behaviour, to report binding of the probe compound or probe molecule with a target peptide or nucleotide sequence.

The term “fluorophore” as used herein refers to a fluorescent chromophore, which may be a compound or molecule, or part of a compound or molecule, that absorbs light energy of a specific wavelength and re-emits energy at a longer wavelength. The wavelength, amount and time before re-emission of the absorbed energy depend on both the fluorophore itself and the chemical environment it interacts with. The chemical structures of fluorophores typically comprise a highly conjugated system enabling delocalization of electrons and contributing to the absorption and re-emission of energy. Fluorophores are commonly used to stain or label tissues, cells or components thereof for fluorescent imaging and spectroscopy.

The term ‘target protein’ as used herein refers to a protein of interest. One or more target proteins may be present at a given time. In one embodiment, a target protein may be a protein which requires to be imaged and have its presence in a cellular matrix confirmed.

The term “peptide segment” as used herein refers to a short polymer chain comprising anywhere from 4 to 30 amino acid monomers being linked together by peptide bonds. Among the amino acid monomers, there are included two or more cysteine groups that are spaced apart by 1 to 6 other amino acids therebetween. A peptide segment of the present invention may be coupled to a target protein, or be incorporated within an amino acid sequence of the target protein.

The term “tag” as used herein may refer to a biological or chemical material, such as a peptide segment of the present invention, that can readily be attached to and has an affinity for a target protein. The peptide segment may be referred to as a ‘peptide tag’. The term ‘to tag a target protein’ as used herein refers to an action or process of coupling a peptide segment to, or incorporating a peptide segment within a sequence of, the target protein and thereby identifies the protein. The coupling may be a direct coupling or indirect coupling.

The word “substantially” does not exclude “completely” e.g. a composition which is “substantially free” from Y may be completely free from Y. Where necessary, the word “substantially” may be omitted from the definition of the invention.

Unless specified otherwise, the terms “comprising” and “comprise”, and grammatical variants thereof, are intended to represent “open” or “inclusive” language such that they include recited elements but also permit inclusion of additional, unrecited elements.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Certain embodiments may also be described broadly and generically herein. Each of the narrower species and subgeneric groupings falling within the generic disclosure also form part of the disclosure. This includes the generic description of the embodiments with a proviso or negative limitation removing any subject matter from the genus, regardless of whether or not the excised material is specifically recited herein.

### DETAILED DISCLOSURE OF EMBODIMENTS

### Disclosed Compounds

Exemplary, non-limiting embodiments of the compounds of formula I having fluorescence properties and their applications will now be disclosed.

The inventors have synthesised the disclosed compounds and found that these compounds exhibit unique fluorescence properties, different from that of the Bodipy core. Advantageously, the inventors have found that an amino acid group comprising a nucleophilic moiety, such as a cysteine group with the thiol moiety, may bind with the compound of formula I and disrupt the conjugation within the disclosed compound. Advantageously, the disruption of the conjugation can produce a significant change in the fluorescence property of the compound of formula I. Accordingly, the compounds disclosed herein can be used as imaging probes to image protein structures or study their functions.

The disclosed compounds or salts thereof may be represented by a general formula I

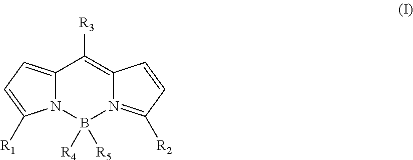

wherein
each of R₁ and R₂ is an optionally substituted alkene having at least one electron withdrawing group moiety;
R₃ is selected from the group consisting of hydrogen, optionally substituted aryl, hydroxyl, amine, sulfonic acid and an optionally substituted aliphatic group;
R₄ and R₅ are independently selected from halogen or an aliphatic group.

In one embodiment, R₁ is an unsubstituted alkene having an electron withdrawing group moiety, while R₂ is a substituted alkene having at least one electron withdrawing group moiety.

In one embodiment, R₂ is an unsubstituted alkene having an electron withdrawing group moiety, while R₁ is a substituted alkene having at least one electron withdrawing group moiety.

In one embodiment, R₁ and/or R₂ may be an alkene substituted with one or more groups independently selected from hydroxyl, alkyl, alkenyl, alkynyl, thioalkyl, cycloalkyl, cycloalkenyl, heterocycloalkyl, halo, carboxyl, haloalkyl, haloalkynyl, hydroxyl, alkoxy, thioalkoxy, alkenyloxy, haloalkoxy, haloalkenyloxy, nitro, amino, nitroalkyl, nitroalkenyl, nitroalkynyl, nitroheterocyclyl, alkylamino, dialkylamino, alkenylamine, alkynylamino, acyl, alkenoyl, alkynoyl, acylamino, diacylamino, acyloxy, alkylsulfonyloxy, heterocycloxy, heterocycloamino, haloheterocycloalkyl, alkylsulfenyl, alkylcarbonyloxy, alkylthio, acylthio, phosphorus-containing groups such as phosphonyl and phosphinyl, aryl, heteroaryl, alkylaryl, alkylheteroaryl, cyano, cyanate, isocyanate, —C(O)NH(alkyl), and —C(O)N(alkyl)₂.

In one embodiment, R₁ and R₂ are the same. For example, R₁ and R₂ may both be an unsubstituted alkene having an electron withdrawing group moiety. In another example, R₁ and R₂ may both be a substituted alkene having an electron withdrawing group moiety, the alkene being substituted with a lower alkyl group, for example. In yet another example, R₁ and R₂ may both be a substituted alkene having two or more electron withdrawing group moieties.

In one embodiment, the alkene moiety of R₁ and R₂ has 2 to 20 carbon atoms. For example, the alkene moiety may comprise 2 to 4 carbons, 2 to 6 carbons, 2 to 8 carbons, 2 to 10 carbons, 2 to 12 carbons, 2 to 14 carbons, 2 to 16 carbons, 2 to 18 carbons, 2 to 20 carbons, 4 to 6 carbons, 4 to 8 carbons, 4 to 12 carbons, 4 to 14 carbons, 4 to 16 carbons, 4 to 18 carbons, 4 to 20 carbons, 6 to 20 carbons, 8 to 20 carbons, 10 to 20 carbons, 12 to 20 carbons, 14 to 20 carbons, 16 to 20 carbons or 18 to 20 carbons.

In one embodiment, the alkene moiety of R₁ and R₂ has 2 carbon atoms.

In one embodiment, the alkene moiety of R₁ and R₂ has to 20, 4 to 12 or 4 to 6 carbon atoms. In this embodiment, R₁ and R₂ may be optionally substituted, conjugated alkenes respectively having electron withdrawing group moieties.

In one embodiment, R₁ and R₂ having 2 to 20 carbon atoms are unsubstituted alkenes having respective electron withdrawing group moieties.

In one embodiment, the at least one electron withdrawing group moiety is adjacent the alkene moiety in each of R₁ and R₂.

In one embodiment, the at least one electron withdrawing group moiety is a substituent on a double bond of the alkene moiety of R₁ and R₂.

In one embodiment where R₁ and R₂ are conjugated alkenes, each having 8 carbons and an electron withdrawing group, for example, the electron withdrawing group may be a substituent on an end double bond of the conjugated alkene moiety in each of R₁ and R₂.

In one embodiment where each of R₁ and R₂ has 2 carbon atoms and an electron withdrawing group moiety, the electron withdrawing group moiety may be a direct substituent on the only double bond existing in R₁ or R₂, and may be in a trans arrangement across the double bond to the Bodipy core.

In another embodiment where R₁ and R₂ are conjugated alkenes, each having 6 carbons and at least one electron withdrawing group for example, the at least one electron withdrawing group may be a substituent on an end double bond and be in a trans arrangement with the remaining double bonds of R₁ or R₂ that are coupled to the Bodipy core.

Advantageously, when the at least one electron withdrawing group moiety is adjacent the alkene moiety in R₁ or R₂, the electron withdrawing group is capable of withdrawing electron density from the alkene moiety, or at least from a double bond of the alkene moiety, thereby making the alkene susceptible to a nucleophilic attack by an electron rich nucleophile, such as the sulfur atom of a thiol group. This type of chemical reaction may be referred to as a nucleophilic addition reaction.

In one embodiment, the at least one electron withdrawing group moiety is selected from the group consisting of a halogen, aldehyde, ketone, ester, carboxylic acid, carbonyl, acyl, acyl chloride, acetyl chloride, trifluoromethyl, nitrile, sulfonic acid, ammonium, amide, amino, azo, nitro, sulfone and phosphonate moiety.

In one embodiment where each of R₁ and R₂ is an alkene having 2 carbon atoms and an electron withdrawing group moiety, R₁ and R₂ are selected from the group consisting of an optionally substituted acrylic ester, acrylic acid, acryloyl, acrylonitrile and acrylamide moiety.

In one embodiment, the acrylic ester, acrylic acid, acryloyl, acrylonitrile and acrylamide moieties may be substituted with one or more groups independently selected from cyano, cyanate, alkoxy, carboxyl, halo, alkyl, alkenyl, alkynyl, aryl, heteroaryl, cycloalkyl and tert-butyl.

In one embodiment, R₁ and R₂ are independently an optionally substituted acrylic ester moiety.

In one embodiment, the ester group of the acrylic ester moiety has 1 to 6 carbon atoms, e.g. the acrylic ester moiety has 1, 2, 3, 4, 5 or 6 carbons.

In one embodiment, the ester group of the acrylic ester moiety has 1 carbon atom, and therefore the acrylic ester moiety is a methyl acrylate.

In one embodiment, R₃ is selected from the group consisting of hydrogen, optionally substituted aryl, hydroxyl, amine, sulfonic acid and an optionally substituted aliphatic group.

In one embodiment, R₃ is an aliphatic group with 1 to 10 carbon atoms. For example, R₃ may be an aliphatic group with 1 to 10, 1 to 9, 1 to 8, 1 to 7, 1 to 6, 1 to 5, 1 to 4, 1 to 2, 2 to 10, 3 to 10, 4 to 10, 5 to 10, 6 to 10, 7 to 10, 8 to 10, or 9 to 10 carbons.

In one embodiment, the aliphatic group of R₃ is an alkyl, preferably a lower alkyl.

In one embodiment, the aliphatic group of R₃ is an aliphatic group containing at least one unsaturated alkenyl or alkynyl group, preferably a lower alkenyl or lower alkynyl group.

In one embodiment, R₃ is an aliphatic group substituted with one or more heteroatom groups. Suitable heteroatom groups include, but are not limited to, oxygen (O), sulfur (S), nitrogen (N) and phosphorus (P).

In one embodiment, R₃ is a substituted aryl.

In one embodiment, R₃ is a substituted naphthyl.

In one embodiment, R₃ is a substituted tolyl.

In one embodiment, R₃ is a substituted phenyl.

In one embodiment, R₃ is a phenyl substituted with one or more groups independently selected from hydroxyl, alkyl, alkenyl, alkynyl, thioalkyl, cycloalkyl, cycloalkenyl, heterocycloalkyl, halo, carboxyl, haloalkyl, haloalkynyl, hydroxyl, alkoxy, thioalkoxy, alkenyloxy, haloalkoxy, haloalkenyloxy, nitro, amino, nitroalkyl, nitroalkenyl, nitroalkynyl, nitroheterocyclyl, alkylamino, dialkylamino, alkenylamine, alkynylamino, acyl, alkenoyl, alkynoyl, acylamino, diacylamino, acyloxy, alkylsulfonyloxy, heterocycloxy, heterocycloamino, haloheterocycloalkyl, alkylsulfenyl, alkylcarbonyloxy, alkylthio, acylthio, phosphorus-containing groups such as phosphonyl and phosphinyl, aryl, heteroaryl, alkylaryl, alkylheteroaryl, cyano, cyanate, isocyanate, —C(O)NH(alkyl), and —C(O)N(alkyl)₂.

In one embodiment, R₃ is a phenyl substituted with a heterocyclic group.

In one embodiment, the phenyl is substituted with a heteroaryl or heteroaliphatic group.

In one embodiment, the heteroaliphatic group may comprise a 3 to 8, 4 to 8, 5 to 8 or 6 to 8 membered ring formed of at least two different elements.

In one embodiment, the heteroaliphatic group comprises a 5 to 8 membered ring formed of three different elements.

In one embodiment, the heteroaliphatic group comprises a 6 membered ring formed of two (2) different elements.

In one embodiment, the heteroaliphatic group comprises a 6 membered ring formed of three (3) different elements.

In one embodiment, the different elements are selected from a group consisting of nitrogen (N), oxygen (O), sulfur (S) and carbon (C).

In one embodiment with the 5 to 8 membered heterocyclic group containing two different elements, the elements are oxygen (O) and carbon (C), or nitrogen (N) and carbon (C).

In one embodiment with the 5 to 8 heterocyclic group containing three different elements, the elements are oxygen (O), sulfur (S) and carbon (C).

In another embodiment with the 5 to 8 membered heterocyclic group containing three (3) different elements, the elements are nitrogen (N), oxygen (O) and carbon (C).

In another embodiment with the 5 to 8 membered heterocyclic group containing three (3) different elements, the elements are oxygen (O), sulfur (S) and carbon (C).

In one embodiment, the heteroaliphatic group comprises a 6 membered ring formed of one nitrogen (N), one oxygen (O) and four carbon (C) atoms.

In one embodiment, the heterocyclic group is a morpholine group.

In one embodiment, the morpholine group has one or more substituents selected from the group consisting of a hydroxyl, halo, alkyl, alkoxy, amido, carbonyl, carboxyl, carbonyl chloride, thiol, sulfonyl and phosphono moiety.

In one embodiment, the heterocyclic group is a morpholinecarbonyl group.

In one embodiment, R₃ is a phenyl substituted with a morpholinecarbonyl group.

In one embodiment, R₄ and R₅ are independently selected from halogen or an aliphatic group.

In one embodiment, R₄ and R₅ are independently a halogen moiety.

In one embodiment, R4 and R5 are independently a fluoro atom.

In one embodiment, the disclosed compound has the formula I-A:

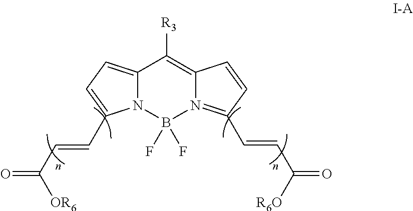

wherein
n is an integer selected from 1 to 10, 1 to 7, 1 to 4 or n=1, n=2 or n=3;
R₃ is independently selected from hydrogen or optionally substituted aryl;
R₆ is hydrogen or a lower alkyl with 1 to 6 carbon atoms.

It should be noted that when R₆ is hydrogen, depending on the pH condition of a surrounding medium when compound I-A is dissolved, the hydrogen may dissociate from the compound I-A, and therefore R₆ may simply be a negative charge (i.e. “−”) in one embodiment; accordingly, the electron withdrawing group moiety in this embodiment is a carboxyl rather than a carboxylic acid group moiety.

Further, compound I-A may also be present as a salt. Therefore, R₆ may be a cation (e.g. Na⁺) in an embodiment of the compound I-A according to the present invention. In this embodiment, if compound I-A was solvated, R₆ may again simply be a negative charge upon dissolution of the salt, or dissociation of the cation (e.g. Na⁺).

In one embodiment, the disclosed compound has the formula I-B:

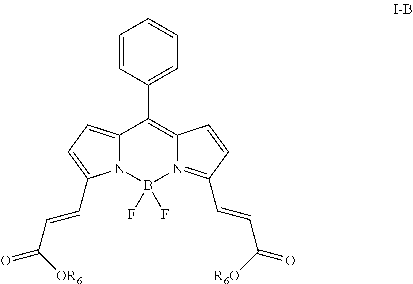

wherein R₆ is hydrogen or a lower alkyl with 1 to 6 carbon atoms. As a lower alkyl, R₆ may be a methyl or ethyl, for example.

In one embodiment, the disclosed compound has the formula I-C:

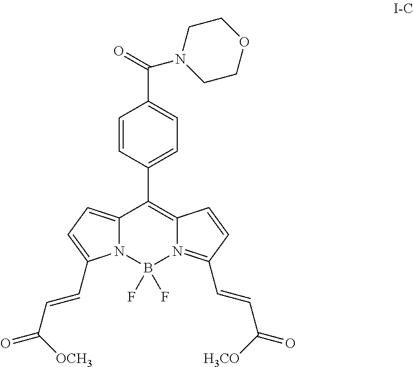

In one embodiment, the disclosed compound has the formula I-D:

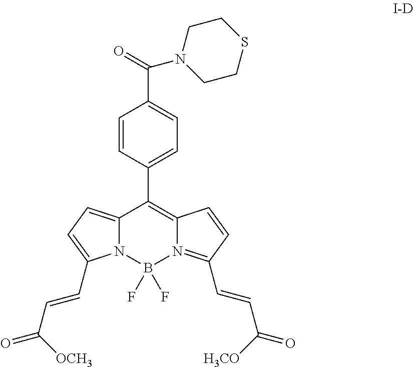

In one embodiment, the disclosed compound has the formula I-E:

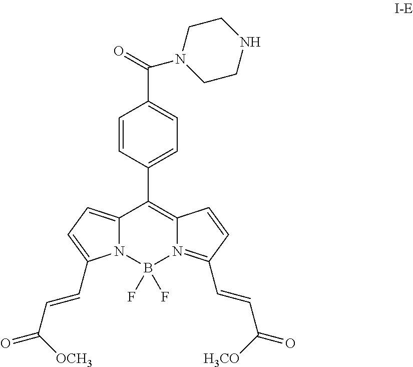

In one embodiment, the disclosed compound has the formula I-F:

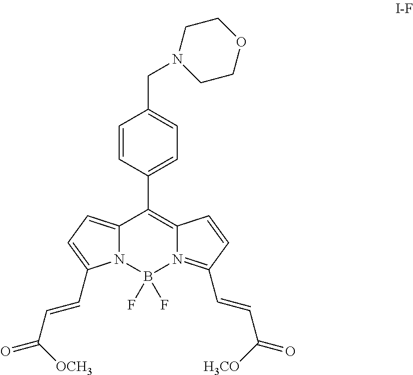

In one embodiment, the disclosed compound has the formula I-G:

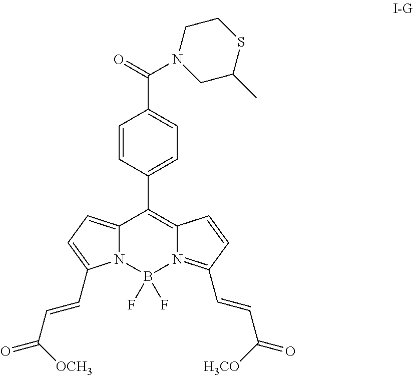

In one embodiment, the disclosed compound has the formula I-H:

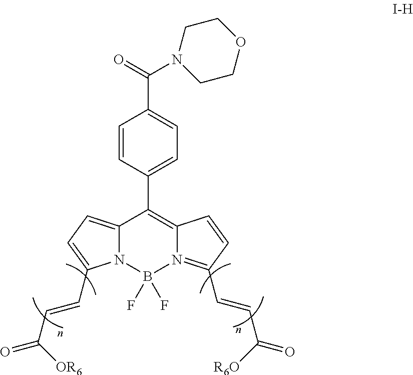

wherein
n is an integer selected from 1 to 10, 1 to 7, 1 to 4 or n=1, n=2 or n=3;
R₆ is H or a lower alkyl with 1 to 6 carbon atoms. As a lower alkyl, R₆ may be a methyl or ethyl, for example. When R₆ is hydrogen, as with the case of compound I-A, depending on the pH condition of a surrounding medium in which compound I-H is dissolved, the hydrogen may dissociate from the compound I-H, and therefore R₆ may simply be a negative charge (i.e. “−”) in one embodiment; accordingly, the electron withdrawing group moiety in this embodiment is a carboxyl rather than a carboxylic acid group moiety.

Further, compound I-H may also be present as a salt. Therefore, R₆ may be a cation (e.g. “Na⁺”) in an embodiment of the compound I-H according to the present invention. In this embodiment, if compound I-H was solvated, R₆ may again simply be a negative charge upon dissolution of the salt, or dissociation of the cation (e.g. Na⁺).

In one embodiment, the disclosed compound has the formula I-I:

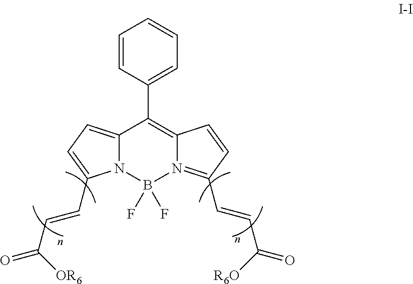

wherein
n is an integer selected from 1 to 10, 1 to 7, 1 to 4 or n=1, n=2 or n=3;
R₆ is H or a lower alkyl with 1 to 6 carbon atoms. As a lower alkyl, R₆ may be a methyl or ethyl, for example.

Similar with embodiments I-A or I-H, R₆ may also be a negative charge (⁻) or a cation (e.g. Na⁺).

In one embodiment, the disclosed compound has the formula I-J:

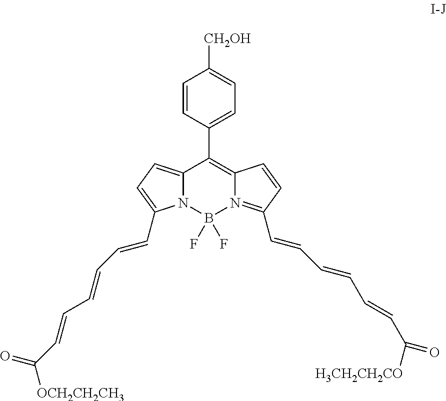

In one embodiment, the disclosed compound has the formula I-K:

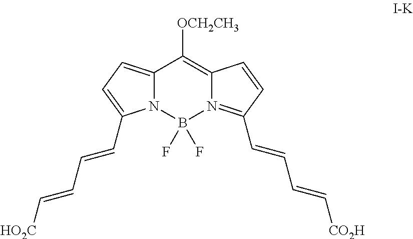

In one embodiment, the disclosed compound has the formula I-L, wherein n=6:

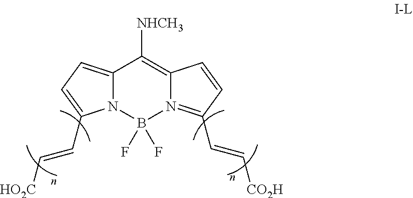

In one embodiment, the disclosed compound has the formula I-M:

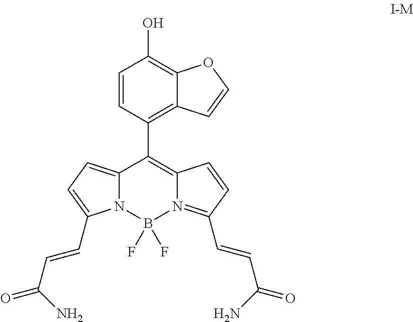

In one embodiment, the disclosed compound has the formula I-N:

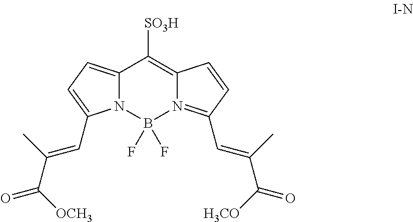

In one embodiment, the disclosed compound has the formula I-O:

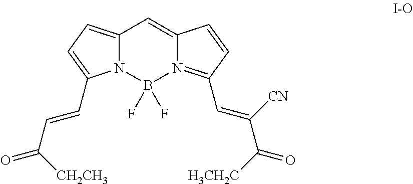

In one embodiment, the disclosed compound has the formula I-P:

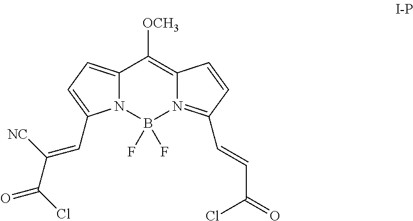

In addition to having one or more alkene substituents, in certain embodiments, the disclosed compounds may have asymmetric carbon centers. These compounds can be present in the form of racemate, diastereomers or mixtures thereof. Therefore, the present invention also includes all these isomers and their mixtures. Thus, compounds of formula (I) and derivatives thereof should be understood to include, for example, E, Z, cis, trans, (R), (S), (L), (D), (+), and/or (−) forms of the compounds, as appropriate in each case.

The disclosed compounds may exist in the form of a salt. The salt may, for example, be formed through a hydrolysis reaction with a dilute alkali solution (e.g. a dilute sodium hydroxide solution). In another embodiment, the salt may be formed with a mineral acid (e.g. hydrochloric acid, sulfuric acid, phosphoric acid) or an organic acid (e.g. acetic acid). In yet another embodiment, the salt may be in the form of a carbonate salt, for example.

The disclosed compounds may exist in solvated or unsolvated forms.

The disclosed compounds may exist in dissociated or undissociated forms.

### Binding Partners

The disclosed invention also provides binding partners for compounds according to the present invention.

The binding partners may be in the form of one or more peptide segments comprising at least one binding motif.

The disclosed peptide segment may comprise at least one cysteine group, but preferably two or more cysteine groups, capable of binding with a disclosed compound to thereby induce a change in a fluorescence property of the compound, the peptide segment capable of being coupled to, or being integrated within a sequence of, a target protein.

Advantageously, the cysteine group comprises an easily accessible nucleophilic thiol moiety.

In one embodiment, the binding between the peptide segment and a disclosed compound involves at least one addition reaction in which the sulfur atom of the cysteine group forms a covalent bond with R₁ or R₂ of the compound, R₁ or R₂ being an alkene having an electron withdrawing group moiety. In this embodiment, the nucleophilic or electron-rich sulfur atom of the thiol moiety may attack the alkene having an electron withdrawing group moiety as in R₁ or R₂.

Advantageously, the addition reaction at the alkene moiety may break the conjugation in the extended conjugated system of the disclosed compound and induces a change in a fluorescence property of the compound, such as shifting the fluorescence back to the green colour of the Bodipy core.

In one embodiment, the peptide segment further comprises an arginine group adjacent the cysteine group, forming a cysteine-arginine or arginine-cysteine pair.

Advantageously, the arginine group would lower the pKa of the thiol moiety in the cysteine group, and increases nucleophilicity of the thiol moiety in physiological pH ranges.

In one embodiment, a disclosed peptide segment may comprise 2 to 5 or 2 to 4 cysteine groups.

In one embodiment, a disclosed peptide segment may comprise three cysteine groups.

In one embodiment, a disclosed peptide segment may comprise two cysteine groups.

In one embodiment, a disclosed peptide segment has two cysteine groups being spaced apart by 1 to 10, 2 to 8, 2 to 6, 2 to 5, 2 to 4 or 2 to 3 amino acids therebetween.

In one embodiment, the two cysteine groups are spaced apart by 3 to 5 or 3 to 4 amino acids therebetween.

In one embodiment, the two cysteine groups are spaced apart by 3 amino acids therebetween.

The amino acids separating the two cysteine groups may be selected from the group consisting of alanine, arginine, asparagine, aspartic acid, glutamic acid, glutamine, glycine, histidine, isoleucine, leucine, lysine, methioning, phenylalanine, proline, serine, thereonine, tryptophan, tyrosine and valine.

In one embodiment, each of the two cysteine groups is adjacent to an arginine group, thereby forming two cysteine-arginine or arginine-cysteine pairs in the peptide segment.

In one embodiment, the two cysteine-arginine or arginine-cysteine pairs are spaced apart by 1 to 10, 2 to 8, 2 to 6, 2 to 5, 2 to 4 or 2 to 3 amino acids (other than arginine and cysteine) therebetween.

In one embodiment, the two cysteine-arginine or arginine-cysteine pairs are spaced apart by three amino acids (other than arginine and cysteine) therebetween.

Advantageously, the distance between the two cysteine groups or cysteine-arginine/arginine-cysteine pairs may be selected to approximately correspond to the distance separating the respective alkene having at least one electron withdrawing group moiety in substituents R₁ and R₂. This is to facilitate the formation of covalent bonds between the thiol moieties of the cysteine groups and the alkene moieties of R₁ and R₂.

Most likely, the binding between a disclosed peptide segment and a disclosed compound involves two addition reactions, respectively between two cysteine groups of the disclosed peptide segment and substituents R₁ and R₂ of the disclosed compound.

Advantageously, the addition reactions and the consequent formation of the covalent bonds enable a stable complex to be formed between a disclosed compound and a disclosed peptide segment.

Therefore, according to a third aspect of the present invention, there is provided a complex comprising a disclosed compound covalently bound to a disclosed peptide segment. In one embodiment, the peptide segment may be coupled to a target protein.

Advantageously, the binding of the disclosed peptide segment to the disclosed compound would break the conjugation in the extended conjugated system of the disclosed compound, and thereby shifting the fluorescence back to the green colour of the Bodipy core. Advantageously, the change in fluorescence properties of the disclosed compound upon binding to a disclosed peptide segment may be used to assist the imaging or study of the target protein.

Therefore, according to a further aspect of the disclosed invention, there is provided a use of a disclosed compound as an imaging probe in conjunction with a disclosed peptide segment to study a target protein.

In a further aspect, there is provided a method of imaging a target protein in a biological matrix, the method comprising the steps of:
a) providing at least one disclosed peptide segment to tag a target protein;
b) providing a compound of formula I to enable covalent binding between the compound of formula I and the at least one peptide segment; and
c) imaging the bound complex in the biological matrix.

In another embodiment, the disclosed peptide segment may be incorporated within an amino acid sequence of the target protein.

In one embodiment, the peptide segment is directly or indirectly coupled to the target protein.

In one embodiment where the disclosed peptide segment is indirectly coupled to the target protein, the peptide segment may be coupled to another small peptide tag, e.g. a myc tag, which may already be bound to the target protein.

In another embodiment, the disclosed peptide segment may be indirectly coupled to the target protein with two or more small peptide tags positioned between the disclosed peptide segment and the target protein.

In another embodiment, the disclosed peptide segment is directly coupled to the target protein. Subsequently, a compound of formula I may be provided to the biological matrix to enable covalent binding between the compound of formula I and the disclosed peptide segment. After a complex is formed where the compound of formula I, the disclosed peptide segment and the target protein are coupled to one another, the bound complex may be imaged.

The imaging may take place in the biological matrix. The biological matrix may be an extracellular or intracellular matrix.

In one embodiment, the biological matrix may be a biologically acceptable medium such as a cell culture medium or a nutrient medium.

Advantageously, the disclosed method may be used to image a protein inside live cells. Therefore, in one embodiment, the biological matrix is a matrix inside live cells.

In one embodiment, a compound selected from the list of I-A to I-I, I-C to I-H or I-C to I-E may be used in the method for imaging of a target protein inside live cells.

In another embodiment, a compound of I-C may be used for the imaging of a target protein inside live cells.

In yet a further aspect, there is provided a an imaging kit comprising a compound of formula I-A, I-B or I-C as an imaging probe and at least one peptide segment comprising two cysteine-arginine or arginine-cysteine pairs.

In one embodiment, the imaging kit comprises 2 to 4 or 2 to 3 identical peptide segments.

In one embodiment, the imaging kit comprises three identical peptide segments.

In one embodiment, the imaging kit comprises two identical peptide segments.

In another embodiment, the imaging kit may comprise two different peptide segments according to the present invention. For example, the first peptide segment may comprise three cycsteine-arginine pairs while the second peptide segment may comprise two cysteine-arginine pairs. Alternatively, the first peptide segment may only comprise two cysteine groups, while the second peptide segment may comprise two cysteine-argine pairs.

### BRIEF DESCRIPTION OF DRAWINGS

The accompanying drawings illustrate a disclosed embodiment and serves to explain the principles of the disclosed embodiment. It is to be understood, however, that the drawings are designed for purposes of illustration only, and not as a definition of the limits of the invention.

FIG. 1 shows the binding of a disclosed compound with a disclosed peptide segment, and effect of the binding on fluorescence property of the disclosed compound.

FIG. 2 shows the fluorescence responses of a disclosed compound in an unbound form and upon binding to a disclosed peptide segment or to various control samples comprising different binding motifs. The different fluorescence emission spectra obtained with excitation at 480 nm are displayed and compared.

FIG. 3a shows a structure of a compound of formula I.

FIG. 3b shows a disclosed peptide segment as compared to three mutant peptide segments; and the expression of a target protein tagged by the disclosed peptide segment.

FIG. 3c shows the binding of a disclosed compound to a disclosed peptide segment and verification of the binding by SDS-PAGE and western blotting (Gel scan Ex/Em=488/Sp 526 nm).

FIG. 4 shows the fluorescence microscopic images of recombinant proteins expressed in 293A cells, wherein the protein is labeled with a peptide tag comprising two disclosed peptide segments for binding a disclosed compound (referred to in Figures and Experimental sections as compound 4b, but is the same as compound of formula I-C).

FIG. 5 shows the LC-MS chromatograms of peptide segments P1, P2, P3, P6 according to the present invention. LC condition of a: (5% ACN to 100% ACN gradient condition with water, contained 0.1% TFA, run time: 10 min, column: C18, 4.6×50 mm, 5 micron, monitored at 214 nm channel) LC condition of b: (15% ACN in water isocratic, contained 0.1% TFA, run time: 20 min, column: C18, 4.6×15 mm, 5 micron, monitored at 214 nm channel).

FIG. 6 compares the spectral properties of compounds referred to as 4a and 4b. Compound 4a relates to a compound of formula I-B wherein R₆ is H. FIG. 6(a) shows absorbance and emission spectra of 4a in 50 mM HEPES buffer (pH 7.4). Fluorescence spectra were obtained with an excitation at 550 nm (Absorption coefficient; =66,888, Quantum Yield; =0.29 over 1,3,5,7-Tetramethyl-8-phenyl BODIPY as a reference). FIG. 6(b) shows absorbance and emission spectra of 4b in 50 mM HEPES buffer (pH 7.4). Fluorescence spectra were obtained with an excitation at 520 nm (Absorption coefficient; =55,989, Quantum Yield; =0.21 over 1, 3, 5, 7-Tetramethyl-8-phenyl BODIPY as a reference).

FIG. 7 shows the reaction rate constants between compound 4a and peptide fragments P1 and P6, respectively. 10 μM of 4a and 200 μM of peptide (P1 or P6*) of 20 mM HEPES buffer solution, containing 1% DMSO, was placed in a 96-well plate. Fluorescent intensity at 530 nm, with an excitation at 480 nm, was recorded every 2 min until saturated under a xenon flash lump. (control peptide without Argenine. P6*: AcGGGGGGGGCGGGCGGG-NH₂)

FIG. 8 shows the Circular Dichroism (CD) spectrum of peptide fragment P1. CD was determined with 1 mM of P1 in 10 mM PBS buffer solution. Buffer reading value was subtracted. Typical helix 209, 220 nm excitations were observed.

FIG. 9 shows the time-dependent fluorescence response of compound 4a incubated with model peptides. 4a (10 μM) was mixed with P1, P2, P3 (10 μM) or NAC (100 μM) in 50 mM HEPES (pH 7.4) and the fluorescence emissions were measured at 530 nm with an excitation at 480 nm.

FIG. 10 shows the conjugation of compound 4a to peptide fragment P1. FIG. 10(a) shows MALDI-TOF spectra of the model peptide P1 after incubation with 4a: 4a (10 μM) and P1 (20 μM) were mixed in 50 mM HEPES (pH 7.0), then mixture was analyzed after desalting by C18 ziptip. Mass indicates the presence of the conjugation product of P1-4a (2268.1, M+H), with another mass peak at 2228.9 (M-38). FIGS. 10(b-d) shows LC-MS chromatogram shift after conjugation with P1 and 4a. Original P1 peptide (Rt=3.3 min) was shifted to 4.3 at 500 nm UV channel. Multiple charged mass was observed at the shifted peak.

FIG. 11 shows the specific conjugation of compound 4b to RC² tagged target proteins in the total proteome. HEK293 cells, transfected with the RC•myc•Cherry and RC²•myc•Cherry or the alanine mutation clones, were stained with 4b (1 μM, 30 min, 37° C.) and the total lysates were analyzed on SDS-PAGE. After fluorescence gel scanning (a), the gel was subjected to silver staining (b) to reveal the total proteome resolved on gel.

FIG. 12 shows the dimerisation of RC tag enables an effective labeling of target protein by 4b in live cells. HEK 293 cells were transfected with the expression vectors encoding Cherry that is tagged with RC, RC² or the alanine mutants of RC (m1, m2, m3) and stained with 4b. Fluorescence microscopic images taken by FITC filter (F) show the green fluorescence resulting from the spectral change of compound and images taken by Cy5 filter (C) prove the expression of tagged protein (Cherry). The arrows in RC tagged Cherry (RC•myc•Cherry) indicate exemplary cells with ultimate overlapping fluorescence signals (i.e. overlapping of green and red fluorescence) as shown in (M). BF-bright field, F-FITC, C-Cy5. M-merged (F and C), Scale bar—50 μm.

FIG. 13 shows fluorescence microscopic images of RC² tagged nuclear protein labeled by compound 4b in HEK293 cells. Cells transfected with the pc-RC²•myc•Cherry or pc-RC²•(NLS)•myc•Cherry and were stained with 4b (1 μM, 15 min, 37° C.) and followed by the Hoechst staining (10 μM, 30 min, 37° C.). Images were taken in live cells. Filters used for fluorescence imaging were BF-bright field, D-DAPI, F-FITC, C-Cy5, M-Merged. Column A shows images of all filters which are merged (BF+D+F+C). The scale bars represent 50 μm.

FIG. 14 shows the labeling of target protein by RC tag at various locations. Plasmid vectors were prepared to express the monomeric Cherry with an RC tag placed in diverse position in combination with other small peptide tags. HEK293 cells transfected with the expression vectors were stained with 4b (1 μM, 30 min, 37° C.) and the total lysates were analyzed on SDS-PAGE. After fluorescence scanning of the gel, protein was transferred to PVDF membrane and was subjected to western blotting (α-myc) for the confirmation exogenous protein expression. represents protein size marker and N represents no transfection.

### EXAMPLES

Non-limiting examples of the invention and a comparative example will be further described in greater detail by reference to specific Examples, which should not be construed as in any way limiting the scope of the invention.

### Materials and Methods

All reactions were performed in oven-dried glassware under a positive pressure of nitrogen. Unless otherwise noted, starting materials and solvents were purchased from Aldrich and Acros organics and used without further purification. Amino acids, Rink amide MBHA resin, and coupling reagents for preparation of peptides were purchased from peptide international, Inc. Analytical TLC was carried out on Merck 60 F254 silica gel plate (0.25 mm layer thickness) and visualization was done with UV light. Column chromatography was performed on Merck 60 silica gel (230-400 mesh). NMR spectra were recorded on a Bruker Avance 400 NMR spectrometer. Chemical shifts are reported as 6 in units of parts per million (ppm) and coupling constants are reported as a J value in Hertz (Hz). Mass of all the compounds was determined by LC-MS of Agilent Technologies with an electrospray ionization source. High resolution mass was recorded on a Bruker MicroTOFQ-II. CD spectra of peptide were measured by Jasco J-810 spectropolarimeter. All fluorescence assays were performed with a Gemini XS fluorescence plate reader. Spectroscopic measurements were performed on a fluorometer and UV/VIS instrument, Synergy 4 of bioteck company. The slit width was 1 nm for both excitation and emission. Relative quantum efficiencies were obtained by comparing the areas under the corrected emission spectrum. The following equation was used to calculate quantum yield

Φₓ=Φₛₜ(Iₓ/Iₛₜ)(Aₛₜ/Aₓ)(ηₓ²/ηₛₜ²)

where st is the reported quantum yield of the standard, I is the integrated emission spectrum, A is the absorbance at the excitation wavelength, and η. is the refractive index of the solvents used. The subscript x denotes unknown and st denotes standard. 1,3,5,7-tetramethyl-8-phenyl Bodipy was used as standards.

### Cell Culture and Transfection

HEK293 cells, an immortalized line of primary human embryonic kidney cells, were purchased from Invitrogen and maintained in the DMEM (10% Fetal Bovine Serum (FBS), 1% antibiotics-antimycotics reagent). Materials used in the cell culture were purchased from Invitrogen. For transient transfection, cells were plated at the density of 2×10⁵ cells/well in 12 well plate and 500 ng of plasmid DNA purified by Midi-prep kit (Qiagen) were transfected with Lipofectamine 2000 (Invitrogen). After 2 days incubation, the transfected cells were subjected to the following experiment such as live cell staining or (SDS-PAGE/western blotting).

### SDS-PAGE, Gel-Scanning, Western Blotting and Silver Staining

Total protein was extracted by using CelLyticM™ cell lysis solution (Sigma). Generally 10 μg of the protein/well was loaded in SDS-PAGE gel for gel-scanning. NuPAGE Novex Bis-Tris Gels (Invitrogen) were used for PAGE and the gel was scanned using the Typhoon 9410 Gel Scanner (GE Healthcare). Gel was excited at stained 488 nm and was scanned through 526SP emission filter. After gel scanning, proteins were transferred onto the PVDF membrane and subjected to the following western blotting. Western blotting data were generated by fluorescence scanning of the membranes stained with antibodies. A mouse monoclonal α-myc (Santa Cruz, sc-40) antibody and a goat α-mouse IgG tagged with Cy5 (Invitrogen, A10524) were used. Membranes were excited at 633 nm and scanned through 670BP emission filter. When the gel was subjected to the silver staining, gel was fixed in fixing solution (50% EtOH, 10% glacial acetic acid) for 10 min. Gel was rinsed with water for 1 hr and then, sensitized in 0.02% Na₂S₂O₃ for 2 min. After a brief rinsing with water, gel was stained in 0.1% AgNO₃ for 30 min. After rinsing with water, gel was developed with 2% Na₂CO₃, 37% (v/v) formaldehyde and the reaction was stopped with 1%.CH₃COOH.

### Compound Staining and Imaging in the Live Cells

Compounds were reconstituted in DMSO as the 1 mM solution, and stored in −20° C. Immediately before staining, medium in the wells were drained and the compound diluted in the pre-warmed growth medium was added directly onto the cells. After incubation (30 min, 37° C.), cells were washed with growth medium and further incubated in the cell culture incubator for 1 hour. Medium was changed once again, and cells were subjected to the live cell imaging. Bright field images and fluorescence images were acquired by a fluorescent microscope ECLIPSE Ti-E (Nikon Instrument Inc.). Emission filters used are DAPI filter (Ex 340-380 nm, Em 435-485 nm) for Hoechst, FITC filter (Ex 465-495 nm, Em 515-555 nm) for 4b, and Cy5 filter (Ex 590-650 nm, Em 663-738 nm) for Cherry.

### Example 1

### Synthesis of Bodipy-Diacrylate Derivatives

Referring to Scheme 1 below, it is shown that dialdehydes were prepared in step a by Vilsmeier formulation of 5-phenyldipyrromethanes. Diacrylates compounds were prepared in step b by Wittig reaction of dipyrromethanes with a triphenylphosphorane reagent. The diacrylate compounds were characterized as a symmetrical E isomer (J=16.0 Hz) by ¹H-NMR. In step c, phenyldipyrromethane acrylates were oxidized by DDQ (2,3-dichloro-5,6-dicyanobenzoquinone) complexed with BF₃.OEt₂ resulting in a deep purple solid of bodipy diacrylates. The process may be represented as follows:

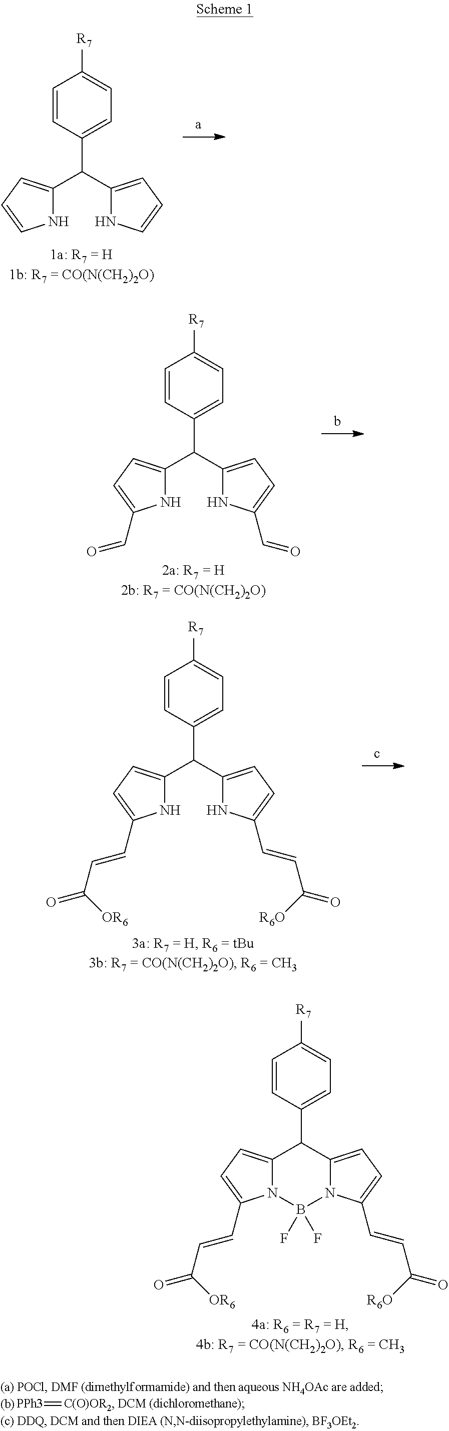

As shown in Scheme 1, multiple reactions were carried out resulting in compound 4a, where R₆=R₇=H and 4b, where R₇=CO(N(CH₂)₂O and R₆=CH₃. With compound 4a, the H may dissociate from the carboxylic acid group depending on the pH of the solution solvating the compound 4a.

It has been found that compound 4a is not sufficiently membrane permeable and therefore an imaging probe comprising compound 4a is best used to study a target protein in an extracellular environment.

Advantageously, compound 4b has been found to be an optimum probe in terms of cell permeability and lower cellular background emission.

### Synthesis of the Starting Material 5-Phenyldipyrromethane (Referred to as 1a)

5-Phenyldipyrromethane was synthesized using process known in the art. ¹H-NMR (300 MHz. CDCl₃) δ 7.87 (bs, 2H, 2-NH), 7.25 (m, 5H, Ph), 6.67 (dd, J=2.4, 4.0, 2H, 2-CH), 6.15 (dd, J=2.8, 6.0, 2H, 2-CH), 5.90 (bs, 2H, 2-CH), 5.45 (s, 1H, —CH); ¹³C-NMR (CDCl₃) δ 142.10, 132.52, 128.67, 128.43, 127.01, 117.24, 108.46, 107.26, 44.01. ESI-MS m/z (M+H) calc'd: 223.1, found 223.1.

### Synthesis of 1,9-Diformyl-Phenyldipyrromethane (an Intermediate Referred to as 2a)

To DMF (10 mL) was added POCl₃ (1.5 mL, 16.4 mmol) slowly, and the mixture was stirred for 5 min at 0° C. This Vilsmeir reagent (7.5 mL, 10.7 mmol) was added slowly to a solution of 2a (1.0 g, 4.5 mmol) in DMF (15 mL), and stirred for 1.5 hr at 0° C. The saturated sodium acetate solution (50 mL) was added and stirred at RT overnight. After the reaction completion monitored by TLC, the reaction mixture was diluted with EtOAc, and washed with water and brine. The organic layer was dried over sodium sulfate. The filtrate was concentrated and purified by silica gel column chromatography (DCM:EtOAc=9:1) to give the greenish yellow solid (1.07 g, 85%). ¹H-NMR (300 MHz, CDCl₃) δ 10.59 (bs, 2H, 2-NH), 9.20 (s, 2H, 2-CHO), 7.31 (m, 5H, -Ph), 6.86 (dd, J=2.4, 4.0, 2H, 2-CH), 6.06 (dd, J=2.4, 3.2, 2H, 2-CH), 5.59 (s, 1H, —CH); ¹³C-NMR (CDCl₃) δ 179.02, 141.64, 139.16, 132.67, 129.00, 128.47, 127.72, 122.31, 111.63, 44.46; ESI-MS m/z (M+H) calc'd: 279.1, found 279.1.

### Synthesis of 1,9-Diformyl-Phenyldipyrromethane (a Further Intermediate Referred to as 3a)

To a solution of 2a (500 mg, 1.80 mmol) in DCM (20 mL) was added (tert-butoxycarbonylmethylene)-triphenylphosphorane (2.03 g, 5.40 mmol) at 0° C., and the mixture was stirred at RT overnight. The reaction mixture was diluted with DCM and washed with brine. The organic layer was dried over sodium sulfate, filtered, concentrated, and purified by silica gel column chromatography (EtOAc:DCM=1:40) to give a greenish yellow solid 3a (375 mg, 44%) ¹H-NMR (400 MHz, CDCl₃) 8.37 (bs, 2H, 2-CH), 7.32 (d, J=16.0, 2-CH), 7.26 (m, 5H, -Ph), 6.42 (app t, J=2.8, 2H, 2-CH), 5.94 (app t, J=2.8, 2H, 2-CH), 5.77 (d, J=16.0, 2H, 2-CH), 5.45 (s, 1H, —CH); ¹³C-NMR (CDCl₃); 166.91, 140.24, 136.36, 132.95, 129.02, 128.52, 128.32, 127.63, 114.68, 113.00, 110.38, 80.12, 44.33, 28.25; ESI-MS m/z (M+H) calc'd: 475.2, found 475.2

### Synthesis of the End Product Bodipy Diacrylic Acid (Referred to as 4a Above)

To a solution of 3a (200 mg, 0.421 mmol) in DCM (35 mL) was added DDQ (144 mg, 0.636 mmol). After stirring for 15 min at RT, the mixture was cooled to 0° C. To this mixture, DIEA (2 mL, 11.6 mmol) and BF₃OEt₂ (1.4 mL, 11.1 mmol) were added and slowly warmed up to RT while stirring for 2 hrs. The reaction mixture was diluted with DCM, and washed with aq. NaHCO₃ and brine. The organic layer was dried over sodium sulfate and the filtrate was concentrated and purified by silica gel chromatography. To hydrolyze the tert-butyl ester BF₃OEt₂ (0.3 mL) was added at 0° C. to the solution of ester in DCM (70 mL). After stirring for 1 hr, the reaction mixture was diluted with DCM and acidified to pH 3 with aq. HCl solution. The aqueous layer was extracted with 5% iPrOH/DCM five times. The organic layer was dried over sodium sulfate. The filtrate was concentrate and purified by silica gel chromatography (MeOH:DCM:H₂O=10:50:1) to give 4a (60 mg, 80%) ¹H-NMR (400 MHz, CDCl₃+CD₃OD) δ 8.11 (d, J=16.0, 2H), 7.58 (m, 5H, Ph), 7.04 (d, J=4.0, 2H), 6.96 (d, J=4.0, 2H), 6.66 (d, J=16.0, 2H); ¹³C-NMR (CDCl₃+CD₃OD) 167.88, 131.98, 131.62, 131.41, 130.80, 130.17, 128.47, 128.29, 128.11, 127.35, 126.01, 125.35; ESI-HRMS m/z (M+Na)⁺ calc'd: 431.0985, found 431.0990.

### Synthesis of an Intermediate (4-(di(1H)-pyrrol-2-yl)methyl)phenyl)(morpholino)methanone (Referred to as 1b)

To a solution of 4-(morpholine-4-carbonyl)benzaldehyde (220 mg, 1.0 mmol) in DCM (10 ml), pyrrole (2.2 mmol) was added. The mixture was blown under nitrogen for 10 min. TFA (0.1 mmol) was added. The reaction mixture was stirred at room temperature for 4 hrs. The reaction was quenched with 0.2 N NaOH aqueous solution (20 ml) and extracted with EtOAc. The organic layer was washed with brine and dried over sodium sulfate. The filtrate was concentrated and purified by silica gel chromatography (DCM:EtOAc=8:1) to give 1b (108 mg, 32%). ¹H-NMR (300 MHz, CDCl₃) δ 8.06 (bs, 2H, 2-NH), 7.35 (d, J=8.4, 2H, 2-CH), 7.26 (d, J=8.4, 2H, 2-CH), 6.70 (dd, J=1.8, 4.2, 2H, 2-CH), 6.16 (dd, J=3.0, 6.0, 2H, 2-CH), 5.90 (bs, 2H, 2-CH), 5.49 (s, 1H, —CH), 3.71 (bt, 8H, 4-CH₂—); ¹³C-NMR (CDCl₃) δ 170.2, 144.20, 131.70, 128.53, 127.63, 127.41, 117.42, 108.44, 107.32, 66.83, 43.78, 38.66. ESI-MS m/z (M+H)⁺ calc'd: 336.2, found 336.1.

### Synthesis of a Further Intermediate (5,5′-((4-(morpholine-carbaldehye)(Referred to as 2b)

To DMF (1 mL) was added POCl₃ (150 μL, 1.60 mmol) slowly, and the mixture was stirred for 5 min at 0° C. This Vilsmeier reagent (750 mL, 1.10 mmol) was added slowly to a solution of 1b (150 mg, 0.45 mmol) in DMF (1.50 mL), and stirred for 1.5 hr at 0° C. The saturated sodium acetate solution (5 mL) was added and stirred at RT overnight. After the reaction completion monitored by TLC, the reaction mixture was diluted with EtOAc, and washed with water and brine. The organic layer was dried over sodium sulfate. The filtrate was concentrated and purified by silica gel column chromatography (DCM:EtOAc=5:1) to give the greenish yellow solid (142 g, 81%). ¹H-NMR (500 MHz, CDCl₃) δ 10.67 (bs, 2H, 2-NH), 9.32 (s, 2H, 2-CHO), 7.34 (d, J=8.4, 2H, 2-CH), 7.24 (d, J=8.4, 2H, 2-CH), 6.90 (dd, J=1.8, 4.2, 2H, 2-CH), 6.09 (dd, J=2.4, 3.2, 2H, 2-CH), 5.60 (s, 1H, —CH), 3.72 (bt, 8H, 4-CH₂—); ¹³C-NMR (CDCl₃) δ 176.09, 163.61, 146.38, 137.67, 131.53, 130.60 129.22, 128.36, 128.33, 123.08, 111.92, 67.45, 54.09, 39.24; ESI-MS m/z (M+H)⁺ calc'd: 391.2, found 391.1.

### Synthesis of the End Product (Referred to as 4b Above)

To a solution of 2b (40 mg, 0.10 mmol) in DCM (1 mL) was added methoxycarbonylmethylene triphenylphosphorane (100 mg, 0.30 mmol) at 0° C. After stirring at RT overnight, the reaction mixture was diluted with DCM and washed with brine. The organic layer was dried over sodium sulfate. The filtrate was concentrated and purified by silica gel column chromatography (DCM:EtOAc=8:1) to give a greenish yellow solid (36 mg, 71%); This yellow solid (36 mg, 0.07 mmol) was dissolved in DCM (7 mL). To this solution was added DDQ (24 mg, 0.11 mmol). After stirring for 15 min at RT, the reaction mixture was cooled to 0° C. To this solution, DIEA (295 uL, 1.75 mmol) and BF₃OEt₂ (225 uL, 1.75 mmol) were added and slowly warmed up to RT while stirring for 2 hrs. The reaction mixture was diluted with DCM, and washed with saturated NaHCO₃ and brine. The organic layer was dried over sodium sulfate. The filtrate was concentrated and purified by silica gel chromatography (DCM:EtOAc=10:1) to give 4b (24 mg, 62%) ¹H-NMR (500 MHz, CDCl₃) δ 8.14 (d, J=15.9, 2H, 2-CH), 7.55 (m, 4H, -Ph), 6.91 (d, J=4.5, 2H, 2-CH), 6.87 (d, J=4.5, 2H, 2-CH), 6.60 (d, J=15.9, 2H, 2-CH), 3.87 (s, 6H, 2-CH₃), 3.84 (bt, 4H, 2-CH₂—), 3.80 (bt, 4H, 2-CH₂—); ¹³C-NMR (CDCl₃) 169.14, 166.14, 132.95, 132.15, 132.02, 131.99, 131.57, 130.67, 128.60, 128.44, 127.39, 125.53, 66.86, 58.19, 29.70; ESI-HRMS m/z (M+Na)⁺ calc'd: 572.1780, found 572.1786.

### Example 2

### Preparations of Peptide Segments (P1-P6)

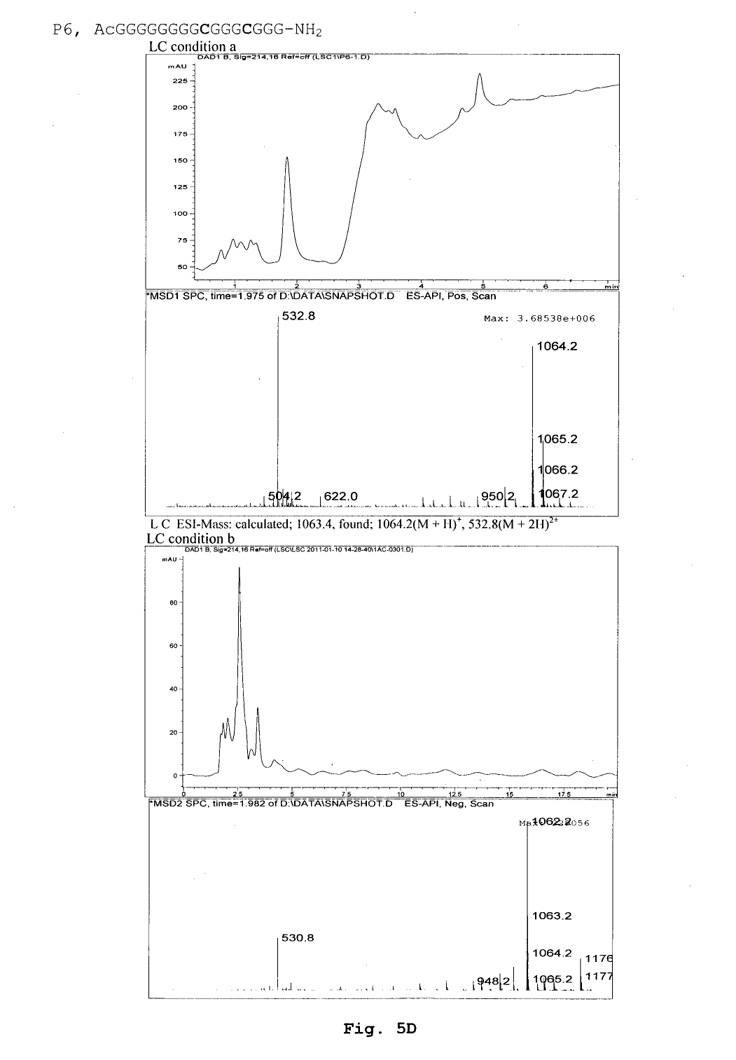

Peptides were synthesized on Rink Amide MBHA resin with standard Fmoc-protected amino acids/HBTU coupling steps followed by piperidine deprotection [Coupling step conditions: Resin (100 mg, 0.48 mmol/g), 0.5 M HBTU in DMF (0.6 mL), 0.5 M Pmoc-Amino acid in NMP (0.6 mL) and 2.0 M DIEA in NMP (0.42 mL) for 3.5 hrs; Deprotection condition: 20% piperidine in NMP (1.5 mL) for 1 hr]. The final N-terminal was capped by acetylation (0.3 M of Ac₂O and 0.27 M of HOBt in DCM for 2 hrs). Peptides were deprotected and cleaved from the resin with the reagent K solution (TFA:H₂O:thioanisole:phenol:EDT=10 mL:0.5 mL:0.5 mL:0.75 g:0.25 mL). Each cleavage solution was drained to chilled ether (20 mL) to precipitate the peptide. Peptide solutions were kept at −20° C. overnight for the maximal precipitation. The precipitates were filtered and dried. Peptides were purified by reverse phase HPLC on C18 preparative column with a linear gradient from 0˜50% acetonitrile in H₂O containing 0.1% TFA. The collected peptide solutions were lyophilized and the peptide solids were kept at −20° C. Purity was determined by LC-MS with condition of two different column C18, 4.6×50 mm and C18 4.6×150 mm with different eluents composition at the wavelength of 214 nm. The LC-MS chromatograms of peptides P1, P2, P3 and P6 are shown in FIG. 5.

### Example 3

### Calculation Process to Determine the Reaction Rate Constant Between Dye and Peptide

As peptide is large excess, the concentration of peptide was considered to be constant during the reaction with dye. The reaction between dye and peptide was considered as pseudo-first order reaction.

r=k[dye][peptide]=k′[dye]=−d[dye]/dt

d[dye]/[dye]=−k′dt

ln [dye]=−k′t+ln [dye]₀

ln [dye]₀/[dye])=k′t

as [dye]₀/[dye]=[product]_{∞}/([product]_{∞}−[product])=F_{∞}/(F_{∞}−Fₜ)

so if we plot ln(F_{∞}/(F_{∞}−Fₜ)) over time t, the slope value is k′, which is the pseudo-first order reaction rate constant.
[dye]: dye concentration as time t
[dye]₀: dye initial concentration
[product]: product concentration at time t
[product]: product final concentration
F_{∞}: fluorescent intensity of product (530 nm) at saturation.
Fₜ: fluorescent intensity of product (530 nm) at time t

### Example 4

### Construction of the Expression Vectors

Pc-RC•myc: An oligonucleotide (RC•myc) encoding the RC tag (P1 peptide segment) together with the Myc-tag was synthesised (GGGGCTAGCCCACCATGGAAGCTGCCGCACGTGAAGCGAGATGTCG TGAGCGCTGCGCGAGAGAAGCTTGAACAAAAACTCATCTCAGAAGAGGATCTGGGATC CCC, restriction enzyme sites inserted for cloning are underlined). Nucleotides marked in green encode the RC tag and in blue encode the myc tag. Myc tag was inserted to be used as the epitope in the western blotting for the confirmation of recombinant protein expression. Using the “RC•myc” as the template, PCR was performed with two short primers (GGGGCTAGCCCACCATGGAA+GGGGGATCCCAGATCCTCTTC). The resulting PCR product was digested with NheI/BamHI and subcloned into the NheI/BamHI sites of pcDNA3.1(+) (Invitrogen). This clone was named as pc-RC•myc and was used for further subclonings.

pc-RC•myc•Cherry: The open reading frame (ORF) of a red fluorescent protein (mCherry) were amplified using the primers (GCTGGATCCATGGTGAGCAAGGGCGAGGAGGACAACATG+GGGCTCGAGT CACTTGTACAGCTCGTCCATGCCGCCGGTGGA) using the pc-mCherry (Clontech) as the template and inserted into the BamHI/XhoI sites of pc-RC•myc. The resulting plasmid (pc-RC•myc•Cherry) expresses the monomeric Cherry that is tagged with the P1 peptide and the myc-tag.

RC tag mutant clones (m1, m2, m3): Vectors express mCherry fused to three mutant tags were prepared by site-directed mutagenesis PCR. Oligonucleotide sets encoding arginine in the place of cysteine are designed as below.

| | |
|---|---|
| m1_S: | GCACGTGAAGCGAGAGCTCGTGAGCGCTGCGCG |
| m1_AS: | CGCGCAGCGCTCACGAGCTCTCGCTTCACGTGC |
| m2_S: | AGATGTCGTGAGCGCGCCGCGAGAGCTAAG |
| m2_AS: | CTTAGCTCTCGCGGCGCGCTCACGACATCT |
| m3_S: | AGAGCTCGTGAGCGCGCCGCGAGAGCTAAg |
| m3_AS: | CTTAGCTCTCGCGGCGCGCTCACGAGCTCT |

25 ng of pc-RC•myc•Cherry was used as the template for mutations and the PCR-reactions were performed with pfu DNA polymerase with a cycling profile of 95° C. 30 sec, (95° C. 30 sec, 55° C. 60 sec, 68° C. 10 min)×16 cycles. Reaction product was digested with DpnI for 1 hour and transformed to E. coli strain DH5. Acquired mutant clones were confirmed by nucleotide sequencing and designated as pc-(m1) RC•myc•Cherry, pc-(m2) RC•myc•Cherry, pc-(m3)RC•myc•Cherry, respectively.

pc-RC²•myc•Cherry: Oligonucleotides encoding the RC tag with the Myc tag but without Kozak or initiating methionine codon (ATG) was synthesized (RC²•myc: CAAGCTTGAAGCTGCCGCACGTGAAGCGAGATGTCGTGAGCGCTGCGCGAGAGCTGAA TTCGCCGATATCGAACAAAAACTCATCTCAGAAGAGGATCTGGGATCCC). Using the “RC²•myc” as the PCR template, the “RC²•myc” was amplified with primers (CCCAAGCTTGAAGCTGCCGCA+GGGGGATCCCAGATCCTCTTC). The resulting PCR product was digested with HindIII/BamHI and inserted into the HindIII/BamHI sites of the pc-pc-RC•myc•Cherry. The acquired clone has a dimerised RC tag and a myc epitope fused to the Cherry. The amino acid sequence encoded by the resulting RC² is shown below.

| | |
|---|---|
| RC: | MEAAAREARCRERCARA |
| RC²: | MEAAAREARCRERCARAKLEAAAREARCRERCARA |

pc-RC²•(NLS)•myc•Cherry: An oligonucleotide encoding triple copies of nuclear localization signal of the SV40 Large T antigen^{[S2]} was synthesized as below. The oligonucleotides were hybridized in the Tris-buffer (100 mM NaCl, 50 mM Tris-HCl, 10 mM MgCl₂, 1 mM DTT, pH 7.9) by boiling and slowly cooling-down to the room temperature and digested with EcoRI/EcoRV. The digested double stranded DNA fragment was inserted into the EcoRI/EcoRV sites of pc-RC²•myc•Cherry and the resulting clone was named as pc-RC²•(NLS)•myc•Cherry.

3×NLS(S): CCCGAATTCGATCCCAAAAAGAAACGCAAGGTGGATGATCCCAA AAAGAAACGCAAGGTGGATGATCCCAAAAAGAAACGCAAGGTGGATATCGGG

3×NLS(AS): CCCGATATCCACCTTGCGTTTCTTTTTGGGATCATCCACCTTG CGTTTCTTTTTGGGATCATCCACCTTGCGTTTCTTTTTGGGATCGAATTCGGG

pc-RC²•myc•H₂B: ORF of human histone H₂B was PCR amplified using the cDNA of normal human fibroblasts. Primers used the amplification were (GGGGGATCCATGCCT GAACCGGCAAAATC+GGGCTCGAGTCACTTGGAGCTGGTGTACT) and the resulting PCR product was digested with BamHI/XhoI and subcloned into the BamHI/XhoI sites of pc-RC²•myc•Cherry to exchange the ORF of Cherry with that of H₂B.

pc-RC²•myc•H2B•Cherry: The ORF of human H₂B was PCR-amplified with primers (GGGGAATTCATGCCTGAACCGGGCAAAATC+GGGGATATCCTTGGAGCTGGTGTACTTGG) and the PCR product was digested with EcoRI/EcoRV. Digested DNA was inserted into the EcoRI/EcoRV sites of the pc-RC²•(NLS)•myc•Cherry to exchange the NLS with the H2B ORF.

pc-RC•Cherry: ORF of Cherry was amplified with primers (GGGAAGCTTATGGTGAGCAAGGGCGAGGAG+GGGCTCGAGCTTGTACAGC TCGTCCATGCCGCCGGTGGA) and the resulting PCR product was digested with HindIII/XhoI and introduced into the HindIII/XhoI sites of pc-RC•myc•Cherry to generate the pc-RC•Cherry.

pc-6×His•myc•RC•Cherry: Primers GGGCTAGCCACCATGCAT CATCATCATCACCACGAATTCGAACAAAAACTCACTCAGAA+CCCAAGCTTAGCTCTC GCGCAGCGCTCACG) was used to amplify the expression cassette of “6×His tag and RC tag”. The produced PCR product was digested with Nhe1/HindIII and inserted into the NheI/HindIII site of pc-RC•myc•Cherry. pc-Cherry•myc•RC: Primers (GGGAATTCGAACAAAAACTCATCTCAGAAGAGGATCTGGATATCGAAGCT GCCGCACGTGAA+CCCCTCGAGTCAAGCTCTCGCGCAGCGCTC) were used to amplify the “myc tag-RC tag” cassette and resulting —PCR product was digested with EcoR1/Xho1 and cloned into the pcDNA3.1(+), resulting the pc-myc•RC. ORF of Cherry was PCR amplified with (GGGGCTAGCCACCATGGTGAGCAAGGGCGAGGAG+GGGGAATTCCTTGTACAGCTCTCCATGCCGCCGGTGGA) and the acquired PCR product was cloned into the NheI/EcoRI sites of the pc-myc•RC resulting the pc-Cherry•myc•RC.

### Example 5

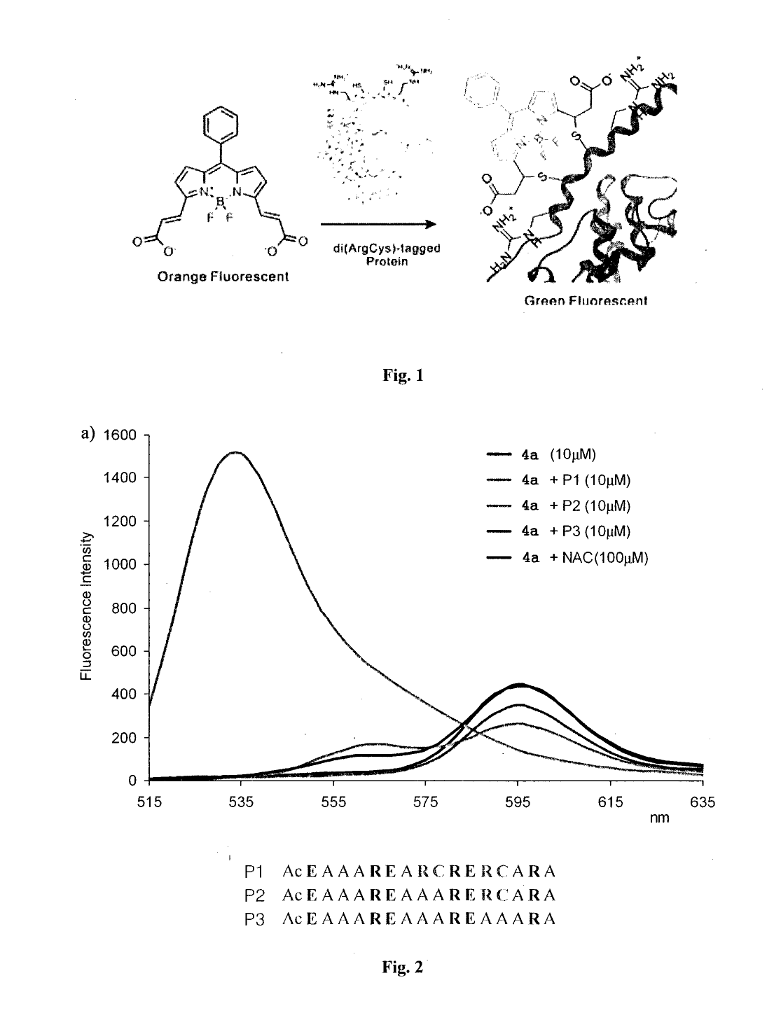

Referring to FIG. 1, there is shown a disclosed compound in which R₁ and R₂ are both an acrylic acid group in its dissociated form. The dissociated compound is shown to form a complex with a disclosed peptide segment coupled to a target protein. The disclosed peptide segment comprises two cysteine groups, each paired with an arginine, thereby forming two arginine-cysteine pairs as shown in FIG. 1. The disclosed compound is bonded to the disclosed peptide segment via the respective thiol moieties of the two cysteine groups. In each instance, the bonding occurs as a result of an addition reaction during which the nucleophilic thiol moiety of a cysteine group attacks the alkene moiety adjacent the electron withdrawing carboxyl group in R₁ or R₂. Therefore, the thiol moiety of the cysteine group acts as a nucleophile while the alkene moiety adjacent the carboxyl group in R₁ or R₂ acts as an electrofile. This addition reaction results in the formation of a covalent bond between the sulfur atom of the cysteine group and the Vcarbon atom in R₁ or R₂.

Advantageously, presence of an arginine group adjacent the cysteine group lowers the pKa of the thiol moiety and increases the nucleophilicity of the cysteine group in physiological pH.

In the embodiment shown in FIG. 1, the distance separating the two alkene moieties in R₁ and R₂ approximately correspond to the distance separating the two thiol moieties, or the cysteine groups. Advantageously, such an arrangement facilitates two addition reactions to take place to enable formation of two covalent bonds between the sulfur atoms of the two cysteine groups and the alkene moieties of R₁ and R₂. Each addition reaction converts the alkene moiety into an alkane moiety and thereby breaks the extended conjugation provided by the alkene moieties of R₁ and R₂ in the disclosed compound 4a.

It can be seen that compound 4a originally emits orange fluorescence (as a result of the extended conjugation provided by substituents R₁ and R₂, each being an acrylic acid moiety). Binding of the disclosed peptide segment to compound 4a, which breaks the extended conjugation in the disclosed compound, results in the bound complex emitting green fluorescence, i.e. reverting to the fluorescence behaviour of the Bodipy core of compound 4a.

### Comparative Example 1

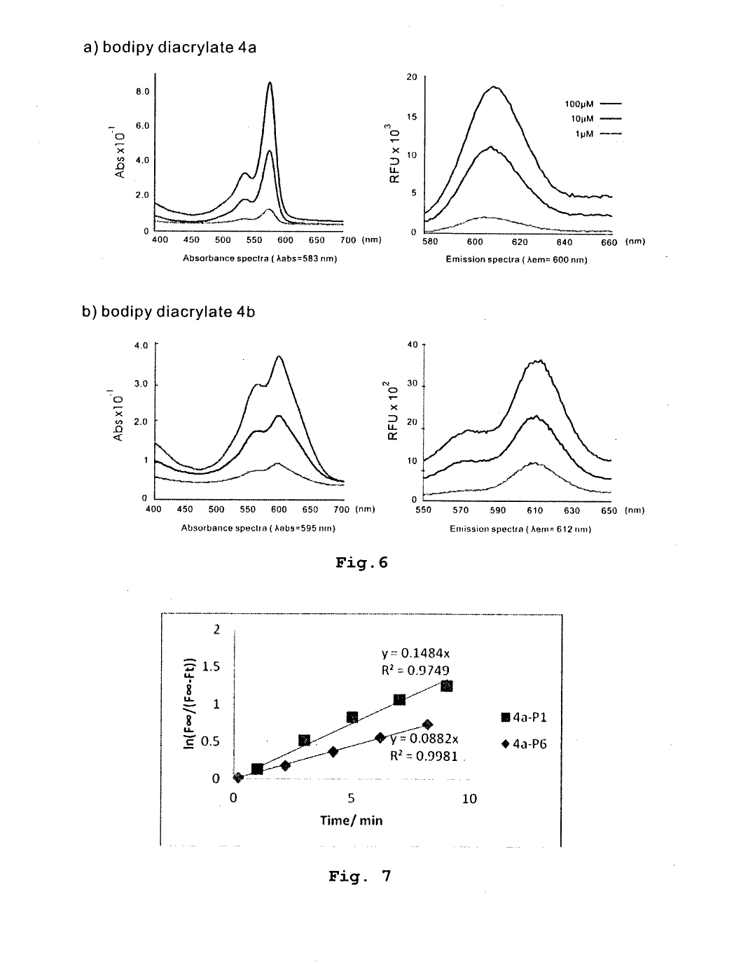

Referring to FIG. 6, the spectral properties of compounds 4a and 4b are compared at various concentrations. It can be seen that both compounds 4a and 4b have fluorescence emission peaks at approximately 610 nm.

### Comparative Example 2

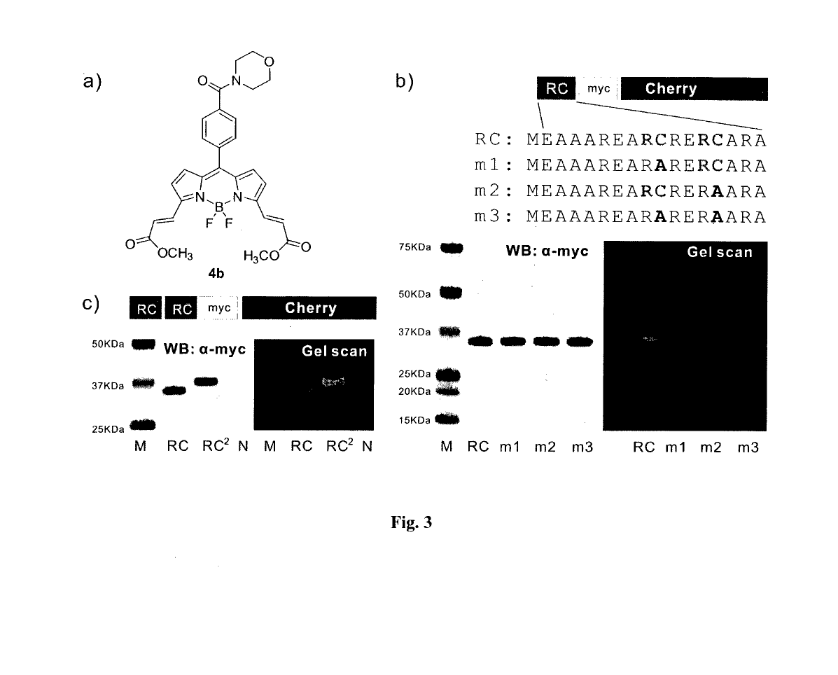

Referring to FIG. 2, there is shown the fluorescence responses of compound 4a by itself and compound 4a incubated with the following in 50 mN HEPES (pH 7.4):

P1: 10 μM of model peptide having two cysteines at the i and i+4 positions, AcEAAAREARCRERCARA, forms an α-helix as demonstrated by CD spectroscopy;
P2: Control peptide with one pair of Arg-Cys, AcEAAAREAAARERCARA;
P3: no Arg-Cys pairs, AcEAAAREAAAREAARA;
NAC: 10-fold excess of N-acetylcysteine.

It can be seen from FIG. 2 that addition of P1 induced an immediate spectral change. This resulted in a large blue shift of emission to green fluorescence (530 nm). The Arg residues appear to contribute to the rapid reaction since control peptide without them (P3) induced a slower reaction. By contrast, P2 gave a slight spectral change with a new emission peak at 565 nm, possibly due to the single conjugation with the Arg-Cys pair, and P3 (the control) shows none. Notably, 10-fild excess of N-acetylcysteine (NAC) induced a small peak at 565 nm.

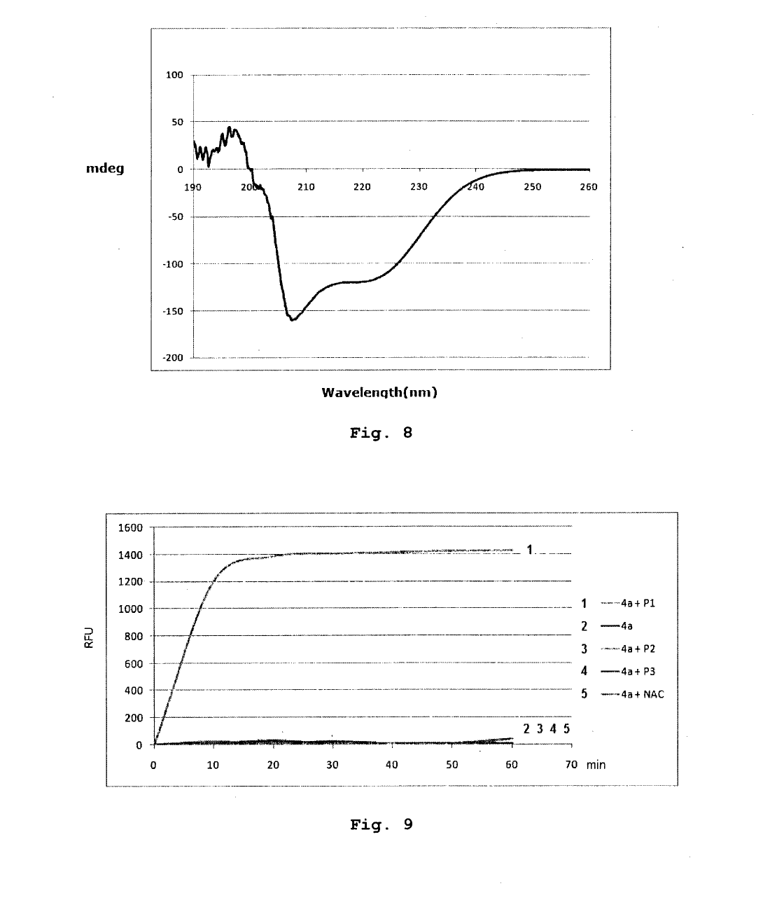

In an appended kinetic study (referring to FIG. 7), it is found that compound 4a and peptide segment P1 has a reaction rate constant of k=0.1484 s⁻¹. In the absence of arginine, a slower reaction takes place as evident from the reaction rate of k=0.0882 s⁻¹ between compound 4a and peptide segment P6 (without arginine).

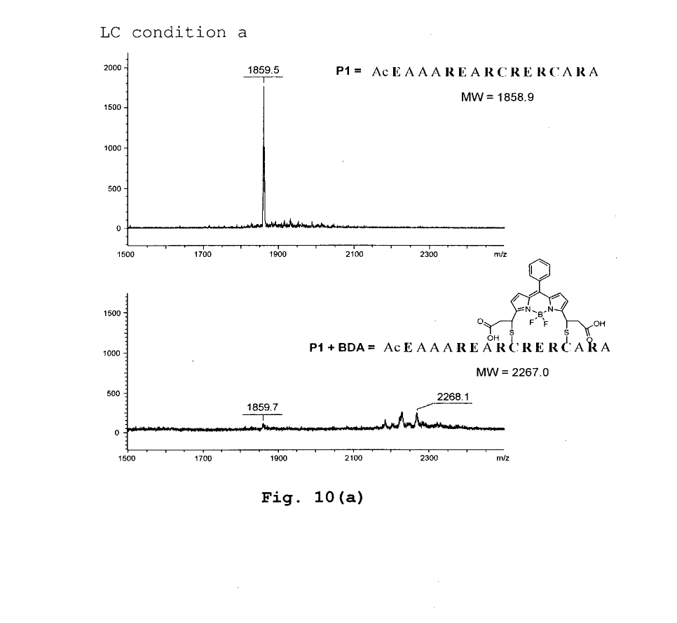

The model peptide P1, as can be seen from FIG. 2c has two cysteine groups at the i and i+4 positions. From another study, P1 was proven to form an α-helix by CD spectroscopy (see FIG. 8).

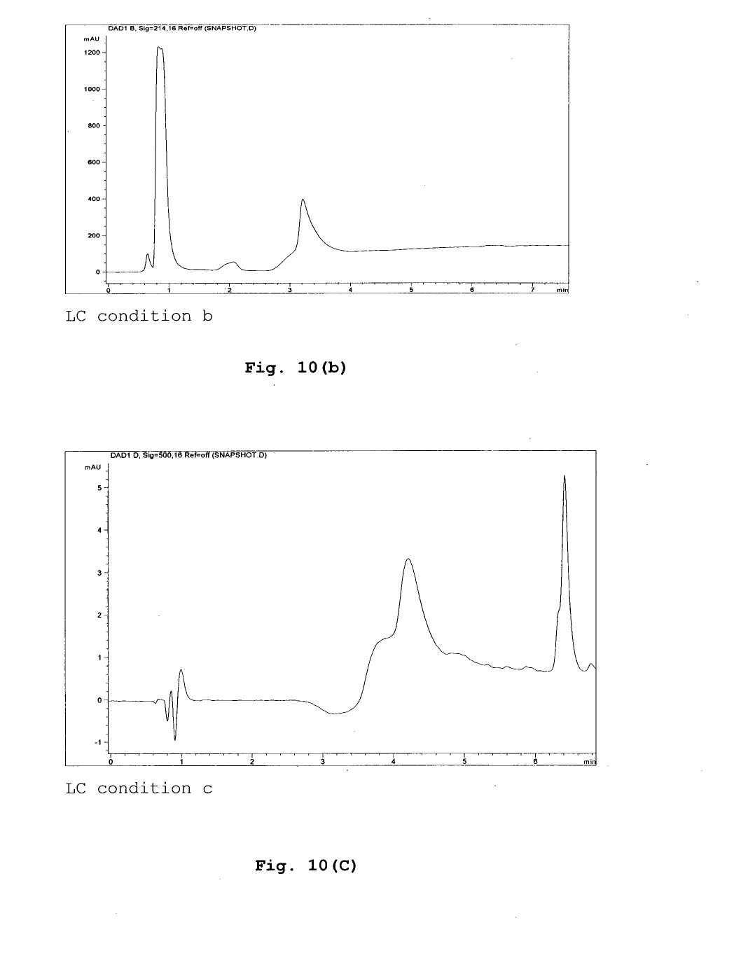

In yet another appended study (referring to FIG. 9), the time dependent fluorescence responses of 4a incubated with the model peptides listed above are determined.

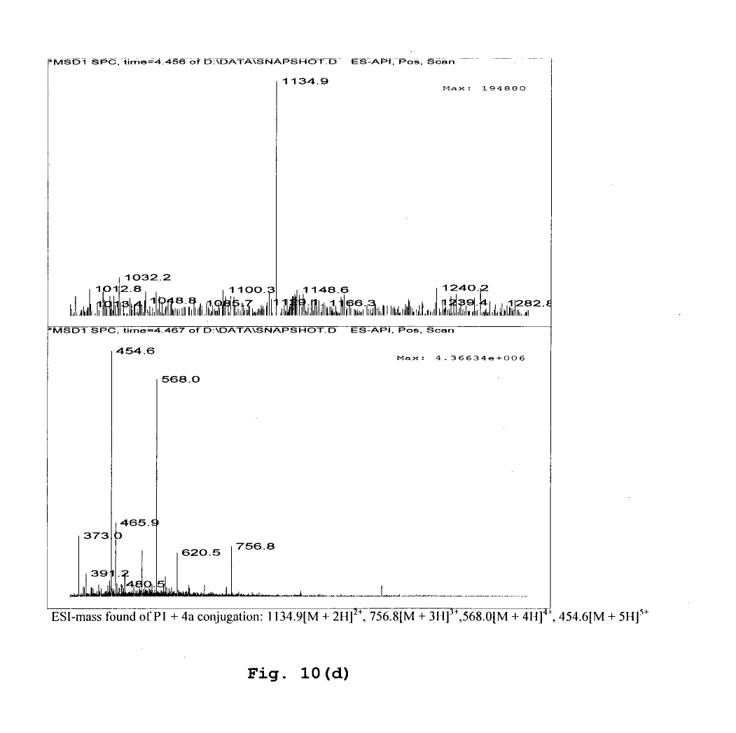

In yet another appended study (referring to FIG. 10), the conjugation between compound 4a and peptide segment P1 is confirmed.

Upon confirmation of the formation of a complex between the disclosed compound 4a and a disclosed peptide segment P1, peptide tags referred to as “RC” tags comprising the amino acid sequences of the disclosed model peptide segment P1 were designed.

### Comparative Example 3

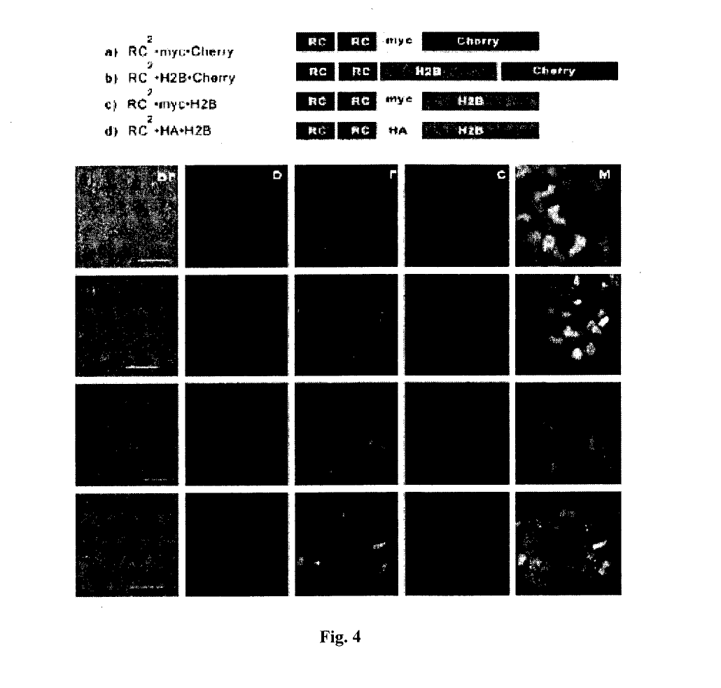

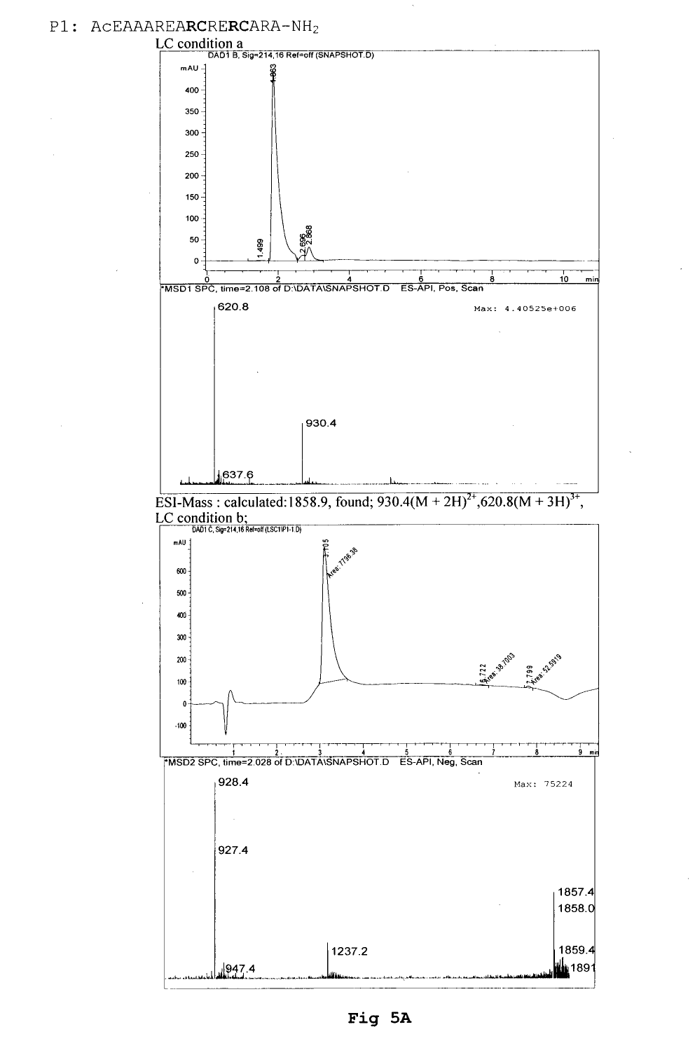

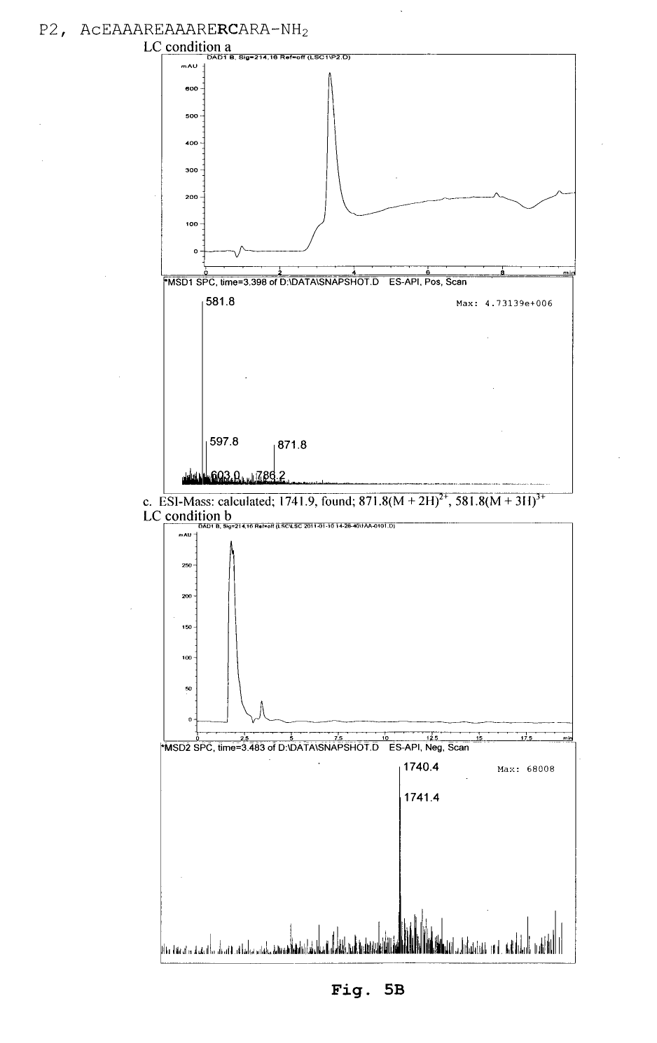

Referring to FIG. 3a, there is shown a structure of a disclosed compound 4b wherein R₃ is a phenyl group substituted with a morpholinocarbonyl moiety, and R₁ and R2 are independently a methyl acrylate moiety. Advantageously, compound 4b exhibits good cell permeability and low cellular background.

Referring to FIG. 3b, there is shown a peptide tag “RC” based on the disclosed peptide segment P1 as mentioned in Comparative Example 2. The peptide tag “RC” is fused to a model protein (monomeric Cherry, a red fluorescent protein). The coupling of the compound 4b to the RC-tagged Cherry is analysed in gel electrophoresis (SDS-PAGE).

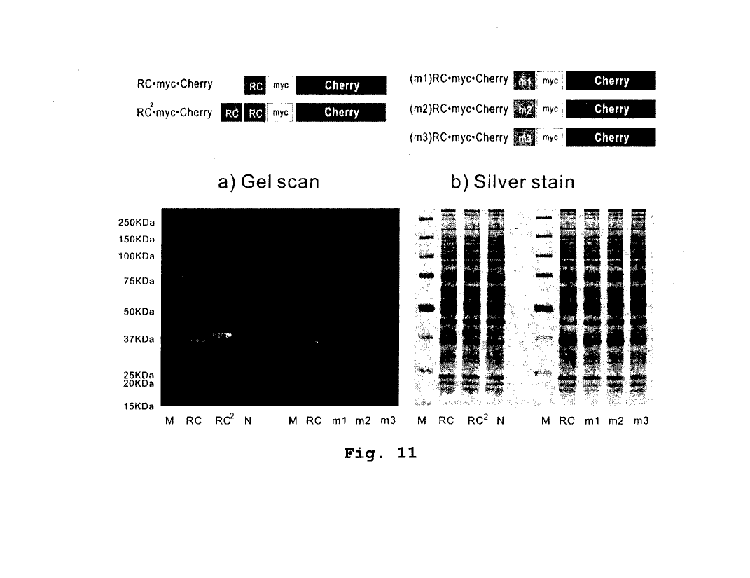

Protein extract of the transfected cells showed an apparent green fluorescence band resulted from the covalent binding of compound 4b to RC-tagged Cherry at the expected molecular weight (34 kDa). It should be noted that this spectral change is achieved only when two cysteine residues are faithfully provided, since mutations on either one or two cysteines in RC tag completely disabled the spectral change as shown in FIG. 3b and FIG. 11.

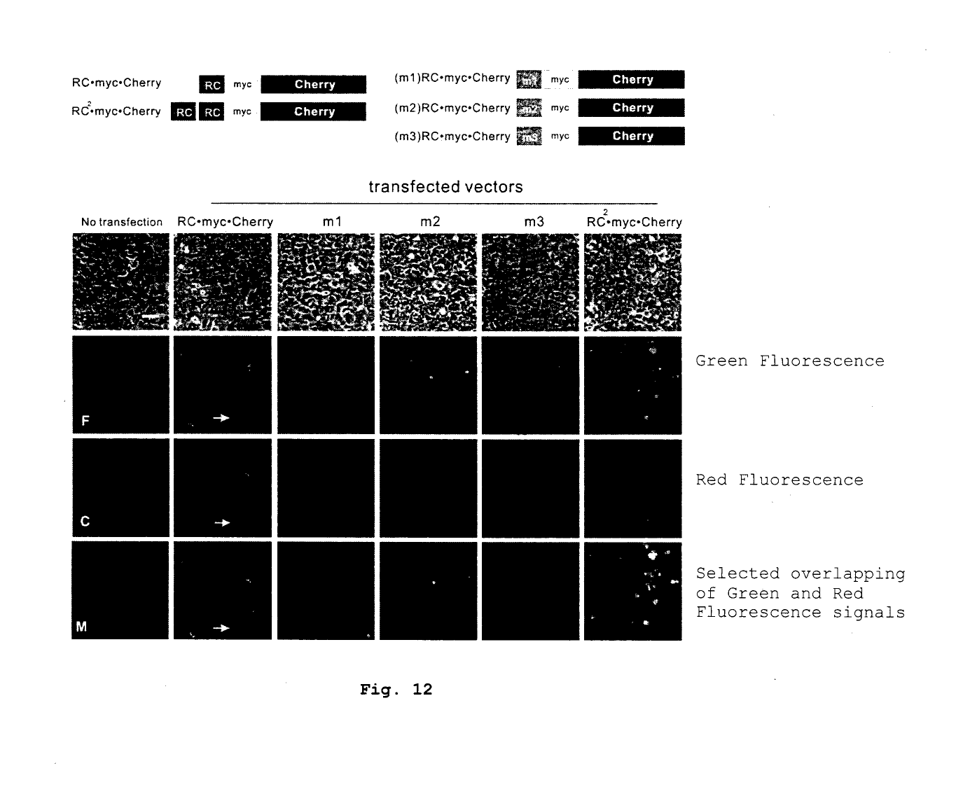

However, when the RC-tagged Cherry was expressed in cells, the green fluorescent signal provided by the staining with 4b was marginally strong to be used for clear optical imaging (see FIG. 12 which shows less or less intense signals in the RC•myc•Cherry column than the RC²•myc•Cherry column). Accordingly, it is proposed to dimerise the RC tag and thereby doubling the binding motif (—RCXXRC) in the tag (RC²).

### Comparative Example 4

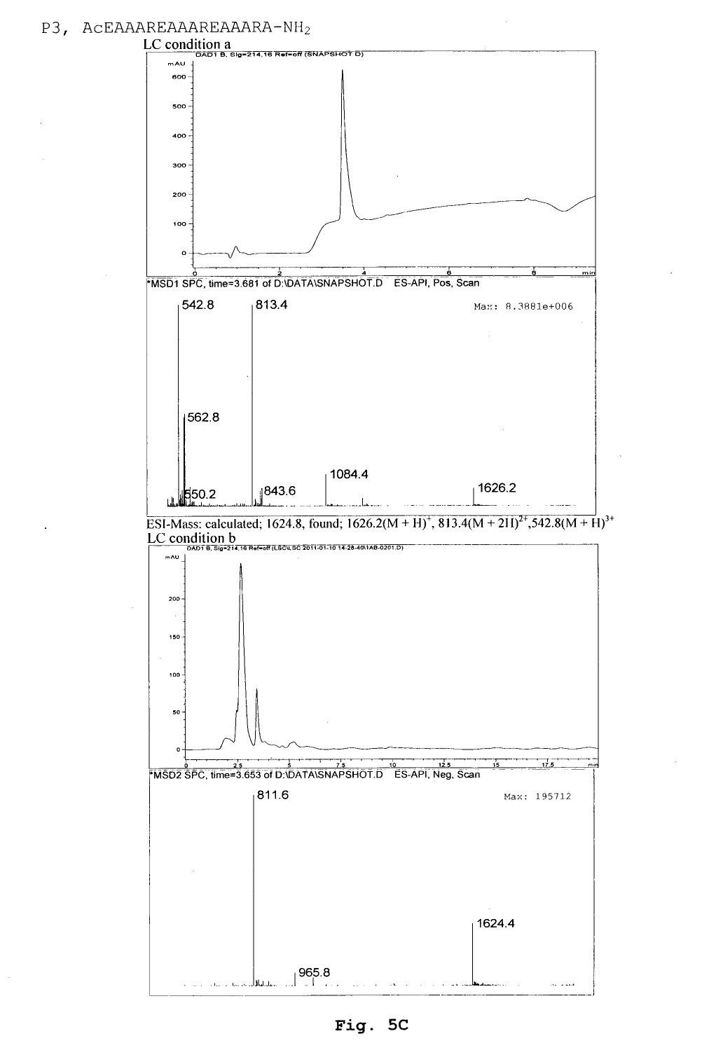

Referring to FIG. 4, there is shown fluorescence microscopic images of compound 4b labeling on the RC² tagged recombinant proteins expressed in 293 A cells. Cells transfected with the respective expression vectors (a˜e) were stained with compound 4b (1 μM, 15 min, 37° C.) and images were taken in live cells. Filters used for fluorescence imaging were BF-bright field, D-DAPI, F-FITC, C-Cy5, M-Merged, Scale bars—50 μm, HA-hemmaglutinin tag.

Advantageously, the RC² tag produced a stronger fluorescent band in gel (see FIG. 3c) than RC.

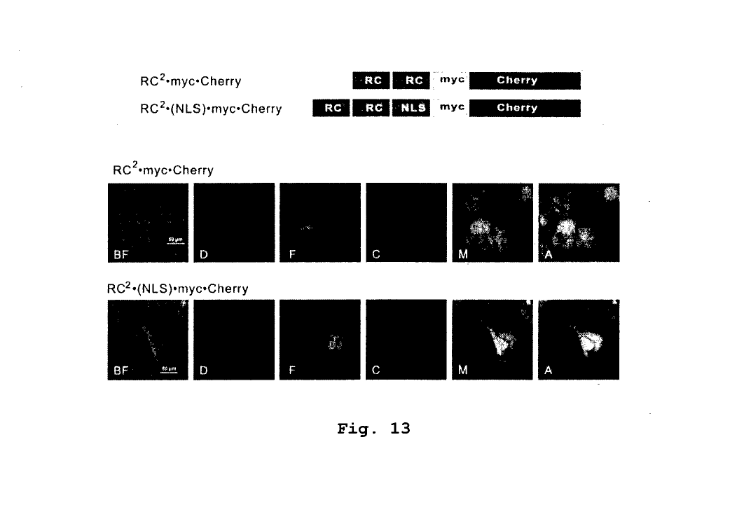

Advantageously, in combining compound 4b with the RC² tag, cell images showed much stronger green fluorescence than with RC tag by the expected spectral change and the green fluorescence overlapped clearly with the red signal from Cherry inside cells (see FIG. 4a and FIG. 12). When the expression of RC² tagged cherry was confined to the nucleus, by introducing a nuclear localization signal (NLS) to the expression cassette, the fluorescence signals from the compound also were strictly localized to the nucleus in transfected cells in accordance with the fluorescence of Cherry that can be observed (see FIG. 13). Noticeably, the signal from the dimeric RC tagged protein (RC²•myc•Cherry) is significantly stronger than the monomeric RC tagged protein (RC•myc•Cherry) as shown in FIG. 12.

The performance of the compound 4b and RC² tag labeling system was tested with histone H2B, as a real cellular protein. In this embodiment, the ‘RC²•myc’ cassette was linked to the N-terminus of human H2B, then Cherry was fused to the C-terminus of human H2B as a marker to check the expression.

Advantageously, probe 4b successfully stained the tagged H₂B in live cells demonstrating clear nuclear staining in the transfected cells (see FIG. 4b).

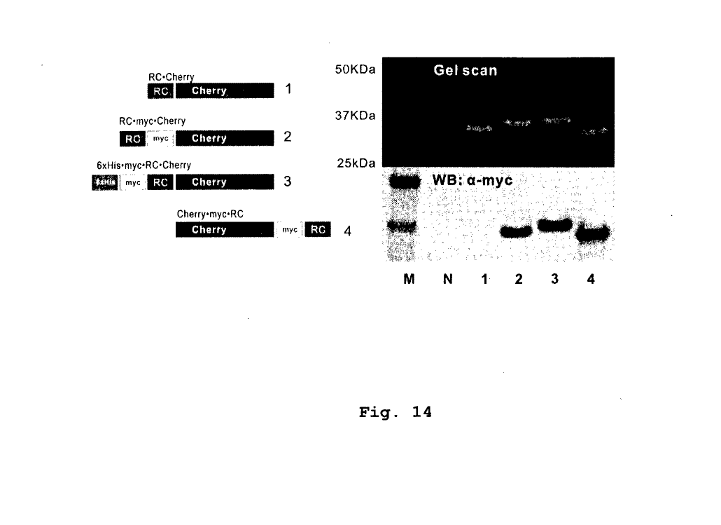

In a parallel experiment of H2B without Cherry, probe 4b and RC² tag provided a reliable labeling to the tagged H2B, which is specific enough to be recognized without the aid of the tracking marker (Cherry) (see FIG. 4c). Additionally, RC² was compatible with other peptide tags. Therefore, combination with other small peptide tags, such as HA tag, myc tag or hexa-histidine tag, is possible, and the combination barely affected the labeling efficiency (see FIG. 4d) and the C-terminal tagging was also available (see FIG. 14).

### APPLICATIONS

The disclosed compound shows promise as a molecular or imaging probe for optical imaging of a protein of interest.

Advantageously, the disclosed compound does not comprise toxic elements such as arsenic atoms and therefore has negligible toxicity.

Advantageously, the disclosed compound is relative small in size and may traverse cell membranes.

Advantageously, the disclosed peptide segment for binding the disclosed compound is also relatively small in size and may traverse cell membranes.

Advantageously, in one embodiment, the distance separating the alkene moieties of the ‘binding arms’ of the disclosed compound may be arranged to approximately correspond to the distance separating the cysteine groups of the peptide segment to facilitate the binding between the disclosed compound and the disclosed peptide segment.

Advantageously, the disclosed compound and peptide segment form a stable complex upon binding.

Advantageously, binding of the disclosed peptide segment to the disclosed compound may produce an immediate and significant spectral change, or a significant change in the fluorescence property of the disclosed compound.

Advantageously, the disclosed compound and peptide segment may be used in a safe and effective way to image or study a target protein in an extracellular environment, or inside live cells.

It will be apparent that various other modifications and adaptations of the invention will be apparent to the person skilled in the art after reading the foregoing disclosure without departing from the spirit and scope of the invention and it is intended that all such modifications and adaptations come within the scope of the appended claims.

1. A compound of formula I 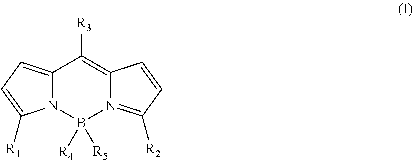
or a salt thereof, wherein
each of R₁ and R₂ is an optionally substituted alkene having at least one electron withdrawing group moiety;
R₃ is selected from the group consisting of hydrogen, optionally substituted aryl, hydroxyl, amine, sulfonic acid and an optionally substituted aliphatic group;
R₄ and R₅ are independently selected from halogen or an aliphatic group.

2. The compound according to claim 1, wherein R₁ and R₂ are the same.

3. The compound according to claim 1, wherein the alkene moiety of R₁ and R₂ has 2 to 20 carbon atoms.

4. (canceled)

5. (canceled)

6. (canceled)

7. The compound according to claim 1, wherein the at least one electron withdrawing group moiety is adjacent the alkene moiety.

8. The compound according to claim 1, wherein the at least one electron withdrawing group moiety is selected from the group consisting of a halogen, aldehyde, ketone, ester, carboxylic acid, acyl chloride, trifluoromethyl, nitrile, sulphonic acid, ammonium, amide, amino, azo, nitro, sulfone and phosphonate moiety.

9. The compound according to claim 1, wherein R₁ and R₂ are selected from the group consisting of an optionally substituted acrylic ester, acrylic acid, acryloyl, acrylonitrile and acrylamide moiety.

10. (canceled)

11. (canceled)

12. (canceled)

13. The compound according to claim 1, wherein R₃ is a substituted aryl.

14. (canceled)

15. (canceled)

16. (canceled)

17. (canceled)

18. The compound according to claim 1, wherein R₄ and R₅ are independently a fluoro atom.

19. The compound according to claim 1, wherein the compound comprises a compound of formula I-A 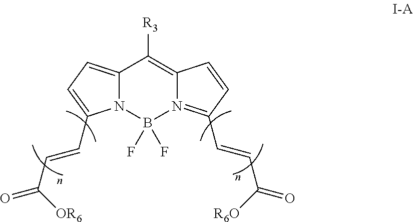
wherein
n is an integer selected from 1 to 10, 1 to 7, 1 to 4 or n=1, n=2 or n=3;
R₃ is independently selected from hydrogen or optionally substituted aryl;
R₆ is hydrogen or a lower alkyl with 1 to 6 carbon atoms.

20. The compound according to claim 1, wherein the compound comprises a compound of formula I-B 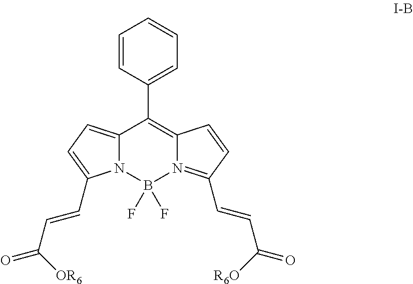
wherein R₆ is hydrogen or a lower alkyl with 1 to 6 carbon atoms.

21. The compound according to claim 1, wherein the compound comprises a compound of formula I-C

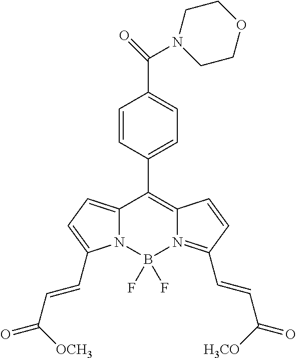

22. A peptide segment comprising two or more cysteine groups capable of binding with the compound of claim 1 to thereby induce a change in a fluorescence property of the compound, the peptide segment capable of being coupled to, or being integrated within a sequence of, a target protein.

23. (canceled)

24. The peptide segment according to claim 22, wherein the binding between the peptide segment and the compound of claim 1 involves the sulfur atom of each cysteine group forming a covalent bond with a respective alkene carbon atom of R₁ and R₂ of the compound of claim 1.

25. The peptide segment according to claim 22, wherein the peptide segment has two cysteine groups being spaced apart by 1 to 10 or 2 to 5 amino acids therebetween.

26. (canceled)

27. The peptide segment according to claim 22, wherein the peptide segment further comprises an arginine group adjacent each cysteine group, thereby forming two cysteine-arginine or arginine-cysteine pairs.

28. The peptide segment according to claim 27, wherein the two cysteine-arginine or arginine-cysteine pairs are spaced apart by 3 amino acids therebetween.

29. The peptide segment according to claim 22 for binding to the compound of claim 1, wherein the distance between the two cyestein groups or cysteine-argining or arginine-cysteine pairs approximately correspond to the distance between the respective alkene moiety of R₁ and R₂.

30. A complex comprising the compound according to claim 1 covalently bound to the peptide segment of claim 22.

31. (canceled)

32. (canceled)

33. A method of imaging a target protein in a biological matrix, the method comprising the steps of:
a) providing the at least one peptide segment of claim 22 to tag a target protein;
b) providing the compound of formula I to enable covalent binding between the compound of formula I and the at least one peptide segment; and
c) imaging the bound complex in the biological matrix.

34. (canceled)

35. (canceled)

36. (canceled)

37. (canceled)

38. (canceled)

39. (canceled)

40. An imaging kit comprising the compound of claim 1 as an imaging probe and at least one peptide segment of claim 22.

41. (canceled)
